(19) United States
(12) Patent Application Publication
(10) Pub. No.: US 2022/0414916 A1
(43) Pub. Date: Dec. 29, 2022

(54) SYSTEMS AND METHODS FOR ASSIGNING A SYMBOL TO AN OBJECT

(71) Applicant: COGNEX CORPORATION, Natick, MA (US)

(72) Inventors: Ahmed EL-BARKOUKY, Hopkinton, MA (US); Emily SAUTER, Cambridge, MA (US)

(21) Appl. No.: 17/850,802

(22) Filed: Jun. 27, 2022

Related U.S. Application Data
(60) Provisional application No. 63/215,229, filed on Jun. 25, 2021.

(51) Int. Cl. G06T 7/70; G06T 7/11; G06T 7/55; G06T 19/20

(52) U.S. Cl. CPC G06T 7/70; G06T 7/11; G06T 7/55; G06T 19/20

(57) ABSTRACT

A method for assigning a symbol to an object in an image includes receiving the image captured by an imaging device where the symbol may be located within the image. The method further includes receiving, in a first coordinate system, a three-dimensional (3D) location of one or more points that corresponds to pose information indicative of a 3D pose of the object in the image, mapping the 3D location of the one or more points of the object to a 2D location within the image, and assigning the symbol to the object based on a relationship between a 2D location of the symbol in the image and the 2D location of the one or more points of the object in the image.

### CROSS-REFERENCE TO RELATED APPLICATIONS

This application is based on, claims the benefit of, and claims priority to U.S. Provisional Application No. 63/215,229, filed Jun. 25, 2021 and entitled “Systems and Methods for Assigning a Symbol to Object,” which is hereby incorporated herein by reference in its entirety for all purposes.

### STATEMENT REGARDING FEDERALLY SPONSORED RESEARCH

N/A

### BACKGROUND

The present technology relates to imaging systems, including machine vision systems that are configured to acquire and analyze images of objects or symbols (e.g., barcodes).

Machine vision systems are generally configured for use in capturing images of objects or symbols and analyzing the images to identify the objects or decode the symbols. Accordingly, machine vision systems generally include one or more devices for image acquisition and image processing. In conventional applications, these devices can be used to acquire images, or to analyze acquired images, such as for the purpose of decoding imaged symbols such as barcodes or text. In some contexts, machine vision and other imaging systems can be used to acquire images of objects that may be larger than a field of view (FOV) for a corresponding imaging device and/or that may be moving relative to an imaging device.

### SUMMARY

In accordance with an embodiment, a method for assigning a symbol to an object in an image includes receiving the image captured by an imaging device where the symbol may be located within the image. The method further includes receiving, in a first coordinate system, a three-dimensional (3D) location of one or more points that corresponds to pose information indicative of a 3D pose of the object in the image, mapping the 3D location of the one or more points of the object to a 2D location within the image, and assigning the symbol to the object based on a relationship between a 2D location of the symbol in the image and the 2D location of the one or more points of the object in the image. In some embodiments, the mapping is based on the 3D location of the one or more points in the first coordinate space

In some embodiments, the method may further include determining a surface of the object based on the 2D location of the one or more points of the object within the image and assigning the symbol to the surface of the object based on a relationship between the 2D location of the symbol in the image and the surface of the object. In some embodiments, the method can further include determining that the symbol is associated with a plurality of images, aggregating the assignments of the symbol for each image of the plurality of images, and determining if at least one of the assignments of the symbol differs from the remaining assignments of the symbol. In some embodiments, the method may further include determining an edge of the object in the image based on imaging data of the image. In some embodiments, the method can further include determining a confidence score for the symbol assignment. In some embodiments, the 3D location of one or more points may be received from a 3D sensor.

In some embodiments, the image includes a plurality of object and the method can further include determining whether the plurality of objects overlap in the image. In some embodiments, the image includes the object having a first boundary with a margin and a second object having a second boundary with a second margin. The method can further include determining whether the first boundary and the second boundary overlap in the image. In some embodiments, the 3D location of the one or more points is acquired at a first time and the image is acquired at a second time. The mapping of the 3D location of the one or more points to the 2D location within the image can include mapping the 3D location of the one or more points from the first time to the second time. In some embodiments, the pose information can include the mapping of the 3D location of the one or more points to the 2D location within the image comprises mapping the 3D location of the one or more points from the first time to the second time. In some embodiments, the pose information may include point cloud data.

In accordance with another embodiment, a system for assigning a symbol to an object in an image includes a calibrated imaging device configured to capture images and a processor device. The processor device may be programmed to receive the image captured by the calibrated imaging device where the symbol located within the image, receive, in a first coordinate system, a three-dimensional (3D) location of one or more points that corresponds to pose information indicative of a 3D pose of the object in the image, map the 3D location of the one or more points of the object to a 2D location within the image, and assign the symbol to the object based on a relationship between a 2D location of the symbol in the image and the 2D location of the one or more points of the object in the image. In some embodiments, the mapping is based on the 3D location of the one or more points in the first coordinate space.

In some embodiments, the system further includes a conveyor configured to support and transport the object, and a motion measurement device coupled to the conveyor and configured to measure movement of the conveyor. In some embodiments, the system can further include a 3D sensor configured to measure the 3D location of the one or more points. In some embodiments, the pose information may include a corner of the object in the first coordinate space. In some embodiments, the pose information may include point cloud data. In some embodiments, the processor device may be further programmed to determine a surface of the object based on the 2D location of the one or more points of the object within the image, and assign the symbol to the surface of the object based on a relationship between the 2D location of the symbol in the image and the surface of the object. In some embodiments, the processor device may be further programmed to determine that the symbol is associated with a plurality of images, aggregate the assignments of the symbol for each image of the plurality of images, and determine if at least one of the assignments of the symbol differs from the remaining assignments of the symbol.

In some embodiments, the image can include a plurality of objects and the processor device may be further programmed to determine whether the plurality of objects overlap in the image. In some embodiments, the image can include the object having a first boundary with a margin and a second object having a second boundary with a second margin. The processor device may be further programmed to determine whether the first boundary and the second boundary overlap in the image. In some embodiments, assigning the symbol to the object can include assigning the symbol to a surface.

In accordance with another embodiment, a method for assigning a symbol to an object in an image includes receiving the image captured by an imaging device. The symbol may be located within the image. The method further includes receiving, in a first coordinate system, a three-dimensional (3D) location of one or more points that corresponds to pose information indicative of a 3D pose of one or more objects, mapping the 3D location of the one or more points of the object to a 2D location within the image in a second coordinate space, determining a surface of the object based on the 2D location of the one or more points of the object within the image in the second coordinate space, and assigning the symbol to the surface based on a relationship between a 2D location of the symbol in the image and the 2D location of the one or more points of the object in the image. In some embodiments, assigning the symbol to the surface can include determining an intersection between the surface and the image in the second coordinate space. In some embodiments, the method can further include comprising determining a confidence score for the symbol assignment. In some embodiments, the mapping is based on the 3D location of the one or more points in the first coordinate space.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A shows an example of a system for capturing multiple images of each side of an object and assigning a symbol to the object in accordance with an embodiment of the technology;

FIG. 1B shows an example of a system for capturing multiple images of each side of an object and assigning a symbol to the object in accordance with an embodiment of the technology;

FIG. 2A shows another example of a system for capturing multiple images of each side of an object and assigning a symbol to the object in accordance with an embodiment of the technology;

FIG. 2B illustrates an example set of images acquired from a bank of imaging devices in the system of FIG. 2A in accordance with an embodiment of the technology;

FIG. 3 shows another example system for capturing multiple images of each side of an object and assigning a symbol to the object in accordance with an embodiment of the technology;

FIG. 4 shows an example of a system for assigning symbols to an object in accordance with some embodiments of the disclosed subject matter;

FIG. 5 shows an example of hardware that can be used to implement an image processing device, a server, and an imaging device shown in FIG. 3 in accordance with some embodiments of the disclosed subject matter;

FIG. 6A illustrates a method for assigning a symbol to an object using images of multiple sides of the object in accordance with an embodiment of the technology;

FIG. 6B illustrates a method for resolving overlapping surfaces of a plurality of objects in an image for assigning a symbol to one of the plurality of objects in accordance with an embodiment of the technology;

FIG. 6C illustrates a method for aggregating symbol assignment results for a symbol in accordance with an embodiment of the technology;

FIG. 7 illustrates an example of an image with two objects where at least one object includes a symbol to be assigned in accordance with an embodiment of the technology;

FIGS. 8A-8C illustrate examples of an image with two objects having overlapping surfaces where at least one object has a symbol to be assigned in accordance with an embodiment of the technology;

FIG. 9 illustrates example images showing an assignment of a symbol to one of two objects with overlapping surfaces in accordance with an embodiment of the technology;

FIG. 10 illustrates an example of determining an assignment of a symbol identified in an image including two objects with overlapping surfaces by using image data in accordance with an embodiment;

FIG. 11 illustrates examples of aggregating symbol assignment results for a symbol in accordance with an embodiment of the technology;

FIG. 12A shows an example of a factory calibration setup that can be used to find a transformation between an image coordinate space and a calibration target coordinate space;

FIG. 12B shows an example of coordinate spaces and other aspects for a calibration process, including a factory calibration and a field calibration that includes capturing multiple images of each side of an object and assigning symbols to an object in accordance with an embodiment of the technology;

FIG. 12C shows examples of a field calibration process associated with different positions of a calibration target (or targets) in accordance with an embodiment of the technology;

FIG. 13A shows an example of correspondence between coordinates of an object in the 3D coordinate space associated with the system for capturing multiple images of each side of the object and coordinates of the object in the 2D coordinate space associated with the imaging device;

FIG. 13B shows another example of correspondence between coordinates of the object in the 3D coordinate space and coordinates of the object in the 2D coordinate space; and

FIG. 14 illustrates an example of determining visible surfaces of one or more objects in an image in accordance with an embodiment.

### DETAILED DESCRIPTION

As conveyor technology improves and objects are moved by conveyors (e.g., a conveyor belt) or other conveyor systems with tighter gapping (i.e., spacing between objects), imaging devices may increasingly capture single images that include multiple objects. As an example, a photo eye can control a trigger cycle of an imaging device, so that image acquisition of a particular object begins when a leading edge (or other boundary feature) of the object crosses the photo eye, and ends when a trailing edge (or other boundary feature) of the object crosses the photo eye. When there are relatively small gaps between adjacent objects on a relevant conveyor, the imaging device can inadvertently capture multiple objects during a single trigger cycle. Further, symbols (e.g., barcodes) positioned on the objects may often need to be decoded using the captured images, such as to guide appropriate further actions for the relevant objects. Accordingly, although it can be important to identify which symbols are associated with which objects, it can sometimes be challenging to accurately determine which object corresponds to a particular symbol within a captured image.

Machine vision systems can include multiple imaging devices. For example, in some embodiments, a machine vision system may be implemented in a tunnel arrangement (or system) which can include a structure on which each of the imaging devices can be positioned at an angle relative to a conveyor resulting in an angled FOV. The multiple imaging devices within a tunnel system can be used to acquire image data of a common scene. In some embodiments, the common scene Can include a relatively small area such as, for example, a tabletop or a discrete section of a conveyor. In some embodiments, in a tunnel system there may be overlap between the FOVs of some of the imaging devices. While the following description refers to a tunnel system or arrangement, it should be understood that the systems and methods for assigning a symbol to an object in an image described herein may be applied to other types of machine vision system arrangements.

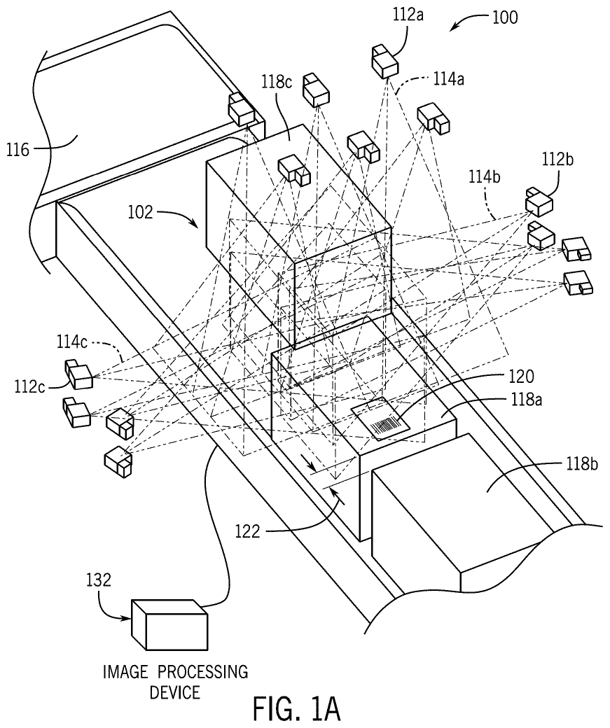

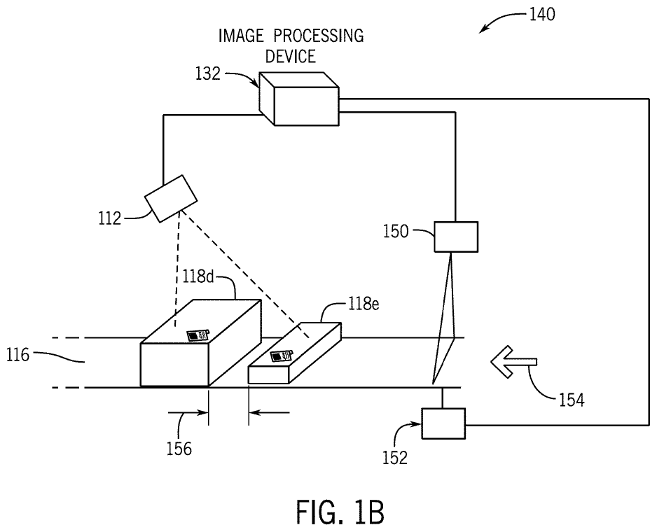

FIG. 1A shows an example of a system 100 for capturing multiple images of each side of an object and assigning a symbol to the object in accordance with an embodiment of the technology. In some embodiments, system 100 can be configured to evaluate symbols (e.g., barcodes, two-dimensional (2D) codes, fiducials, hazmat, machine readable code, etc.) on objects (e.g., objects 118a, 118b) moving through a tunnel 102, such as a symbol 120 on object 118a, including assigning symbols to objects (e.g., objects 118a, 118b). In some embodiments, symbol 120 is a flat 2D barcode on a top surface of object 118a, and objects 118a and 118b are roughly cuboid boxes. Additionally or alternatively, in some embodiments, any suitable geometries are possible for an object to be imaged, and any variety of symbols and symbol locations can be imaged and evaluated, including non-direct part mark (DPM) symbols and DPM symbols located on a top or any other side of an object.

In FIG. 1A, objects 118a and 118b are disposed on a conveyor 116 that is configured to move objects 118a and 118b in a horizontal direction through tunnel 102 at a relatively predictable and continuous rate, or at a variable rate measured by a device, such as an encoder or other motion measurement device. Additionally or alternatively, objects can be moved through tunnel 102 in other ways (e.g., with non-linear movement). In some embodiments, conveyor 116 can include a conveyor belt. In some embodiments, conveyor 116 can consist of other types of transport systems.

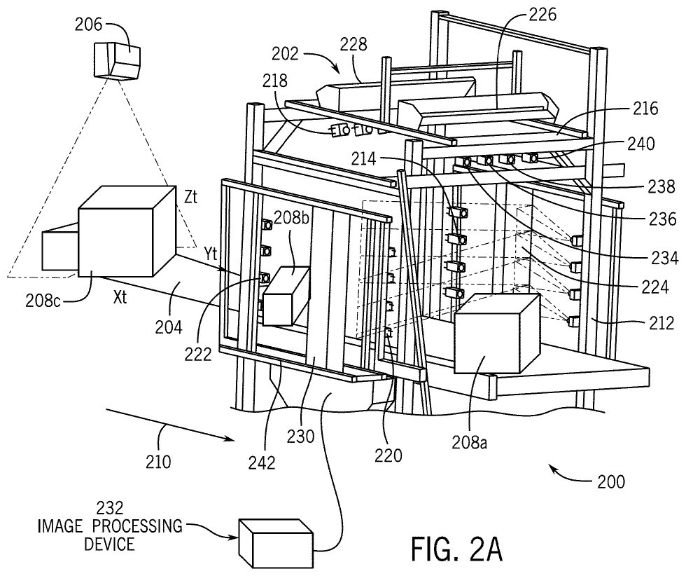

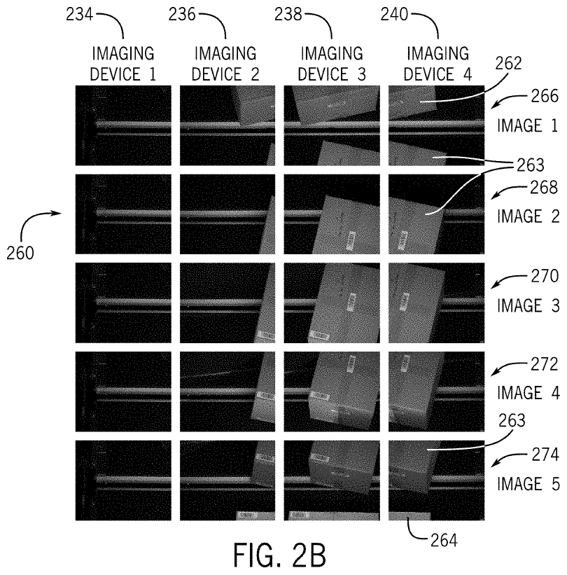

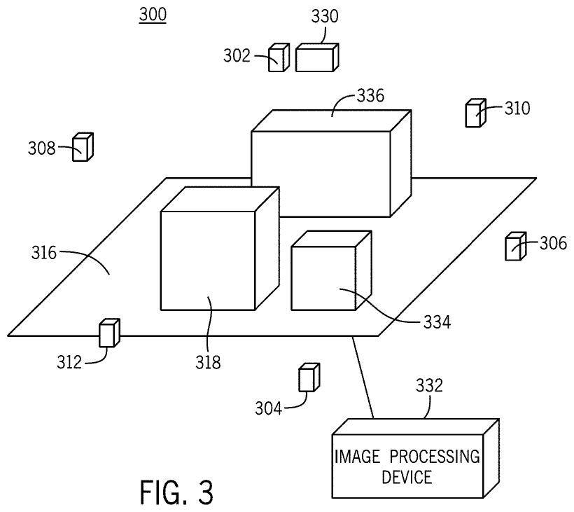

In some embodiments, system 100 can include imaging devices 112 and an image processing device 132. For example, system 100 can include multiple imaging devices in a tunnel arrangement (e.g., implementing a portion of tunnel 102), representatively shown via imaging devices 112a, 112b, and 112c, each with a field-of-view (“FOV”), representatively shown via FOV 114a, 114b, 114c, that includes part of the conveyor 116. In some embodiments, each imaging device 112 can be positioned at an angle relative to the conveyor top or side (e.g., at an angle relative to a normal direction of symbols on the sides of the objects 118a and 118b or relative to the direction of travel), resulting in an angled FOV. Similarly, some of the FOVs can overlap with other FOVs (e.g., FOV 114a and FOV 114b). In such embodiments, system 100 can be configured to capture one or more images of multiple sides of objects 118a and/or 118b as the objects are moved by conveyor 116. In some embodiments, the captured images can be used to identify symbols on each object (e.g., a symbol 120) and/or assign symbols to each object, which can be subsequently decoded or analyzed (as appropriate). In some embodiments, a gap in conveyor 116 (not shown) can facilitate imaging of a bottom side of an object (e.g., as described in U.S. Patent Application Publication No. 2019/0333259, filed on Apr. 25, 2018, which is hereby incorporated by reference herein in its entirety) using an imaging device or array of imaging devices (not shown), disposed below conveyor 116. In some embodiments, the captured images from a bottom side of the object may also be used to identify symbols on the object and/or assign symbols to each object, which can be subsequently decoded (as appropriate). Note that although two arrays of three imaging devices 112 are shown imaging a top of objects 118a and 118b, and four arrays of two imaging devices 112 are shown imaging sides of objects 118a and 118b, this is merely an example, and any suitable number of imaging devices can be used to capture images of various sides of objects. For example, each array can include four or more imaging devices. Additionally, although imaging devices 112 are generally shown imaging objects 118a and 118b without mirrors to redirect a FOV, this is merely an example, and one or more fixed and/or steerable mirrors can be used to redirect a FOV of one or more of the imaging devices as described below with respect to FIGS. 2A and 3, which may facilitate a reduced vertical or lateral distance between imaging devices and objects in tunnel 102. For example, imaging device 112a can be disposed with an optical axis parallel to conveyor 116, and one or more mirrors can be disposed above tunnel 102 to redirect a FOV from imaging devices 112a toward a front and top of objects in tunnel 102.

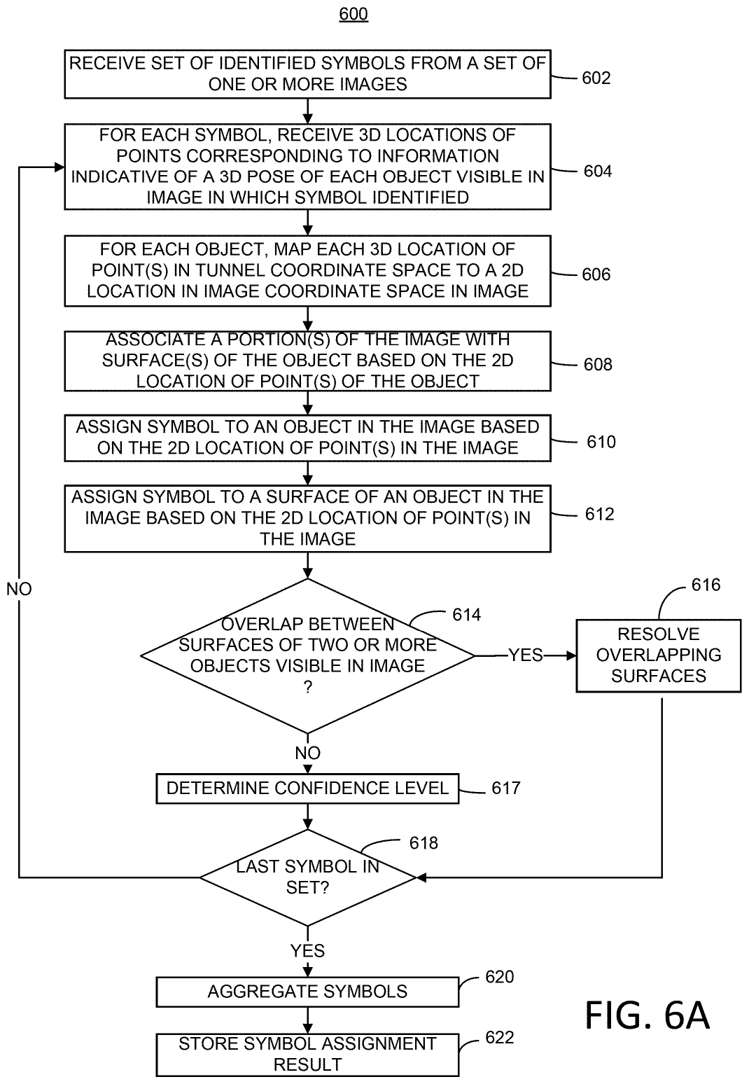

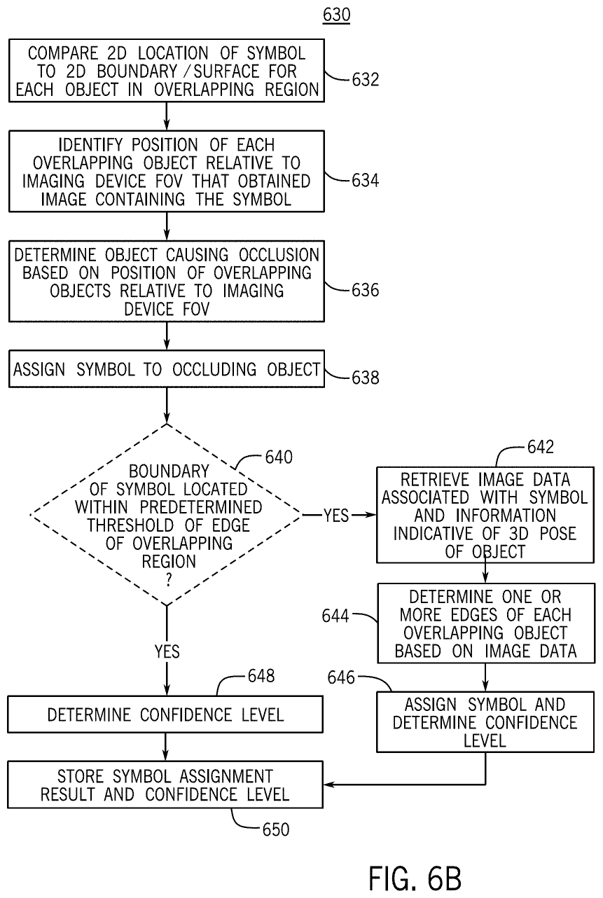

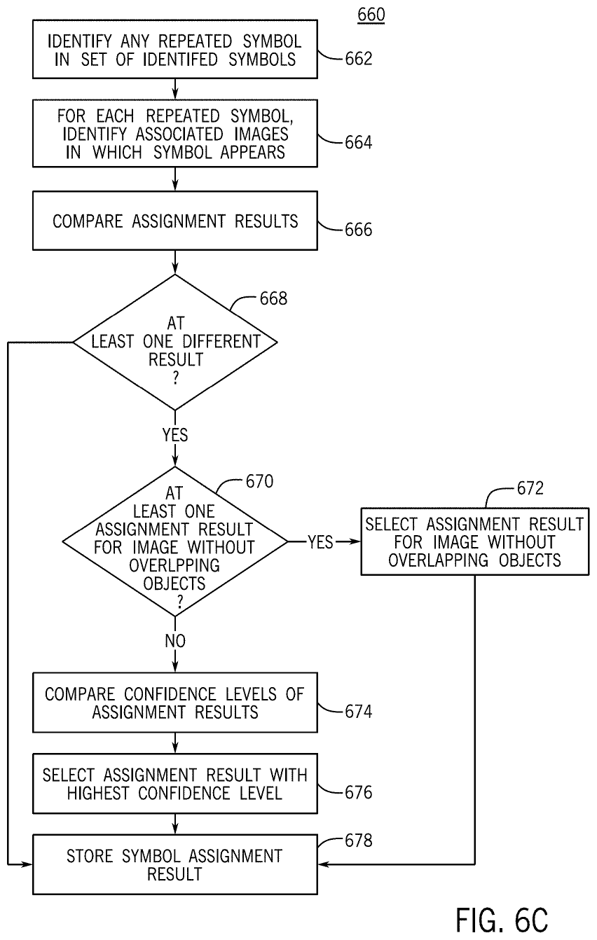

In some embodiments, imaging devices 112 can be implemented using any suitable type of imaging device(s). For example, imaging devices 112 can be implemented using 2D imaging devices (e.g., 2D cameras), such as area scan cameras and/or line scan cameras. In some embodiments, imaging device 112 can be an integrated system that includes a lens assembly and an imager, such as a CCD or CMOS sensor. In some embodiments, imaging devices 112 may each include one or more image sensors, at least one lens arrangement, and at least one control device (e.g., a processor device) configured to execute computational operations relative to the image sensor. Each of the imaging devices 112a, 112b, or 112c can selectively acquire image data from different fields of view (FOVs), regions of interest (“ROIs”), or a combination thereof. In some embodiments, system 100 can be utilized to acquire multiple images of each side of an object where one or more images may include more than one object. As described below with respect to FIGS. 6A-6C, the multiple images of each side can be used to assign a symbol in an image to an object in the image. Object 118 may be associated with one or more symbols, such as a barcode, a QR code, etc. In some embodiments, system 100 can be configured to facilitate imaging of the bottom side of an object supported by conveyor 116 (e.g., the side of object 118a resting on conveyor 116). For example, conveyor 116 may be implemented with a gap (not shown).

In some embodiments, a gap 122 is provided between objects 118a, 118b. In different implementations, gaps between objects can range in size. In some implementations, gaps between objects can be substantially the same between all sets of objects in a system, or can exhibit a fixed minimum size for all sets of objects in a system. In some embodiments, smaller gap sizes may be used to maximize system throughput. However, in some implementations, the size of a gap (e.g., the gap 122), and the dimensions of sets of adjacent objects (e.g., the objects 118a, 118b) can affect the utility of resulting images captured by imaging devices 112, including for analysis of symbols on particular objects. For some configurations, an imaging device (e.g., the imaging device 112) may capture images in which a first symbol positioned on a first object appears in the same image with a second symbol positioned on a second object. Further, for smaller sizes of a gap, a first object may sometimes overlap (i.e., occlusion) with a second object in an image. This can occur, for example, when the size of the gap 122 is relatively small, and a first object (e.g., the object 118a) is relatively tall. When such overlap occurs, it can accordingly sometimes be very difficult to determine if a detected symbol corresponds to a specific object (i.e., if a symbol should be considered “on” or “off” of the object).

In some embodiments, system 100 can include a three-dimensional (3D) sensor (not shown), sometime referred to herein as a dimensioner or dimension sensing system, that can measure dimensions of objects moving toward tunnel 102 on conveyor 116, and such dimensions can be used (e.g., by image processing device 132) in a process to assign a symbol to an object in an image captured as one or more objects move through tunnel 102. Additionally, system 100 can include devices (e.g., an encoder or other motion measurement device, not shown) to track the physical movement of objects (e.g., objects 118a, 118b) moving through the tunnel 102 on the conveyor 116. FIG. 1B shows an example of a system for capturing multiple images of each side of an object and assigning a code to the object in accordance with an embodiment of the technology. FIG. 1B shows a simplified diagram of a system 140 to illustrate an example arrangement of a 3D sensor (or dimensioner) and a motion measurement device (e.g., an encoder) with respect to a tunnel. As mentioned above, the system 140 may include a 3D sensor (or dimensioner) 150 and a motion measurement device 152. In the illustrated example, a conveyor 116 is configured to move objects 118d, 118e along the direction indicated by arrow 154 past a 3D sensor 150 before the objects 118d, 118e are imaged by one or more imaging devices 112. In the illustrated embodiment, a gap 156 is provided between objects 118d and 118e and an image processing device 132 may be in communication with imaging devices 112, 3D sensor 150 and motion measurement device 152. The 3D sensor (or dimensioner) 150 can be configured to determine dimensions and/or a location of an object supported by support structure 116 (e.g., object 118d or 118e) at a certain point in time. For example, 3D sensor 150 can be configured to determine a distance from 3D sensor 150 to a top surface of the object, and can be configured to determine a size and/or orientation of a surface facing 3D sensor 150. In some embodiments, 3D sensor 150 can be implemented using various technologies. For example, 3D sensor 150 can be implemented using a 3D camera (e.g., a structured light 3D camera, a continuous time of flight 3D camera, etc.). As another example, 3D sensor 150 can be implemented using a laser scanning system (e.g., a LiDAR system). In a particular example, 3D sensor 150 can be implemented using a 3D-A1000 system available from Cognex Corporation. In some embodiments, the 3D sensor (or dimensioner) (e.g., a time-of-flight sensor or computed from stereo) may be implemented in a single device or enclosure with an imaging device (e.g., a 2D camera) and, in in some embodiments, a processor (e.g., that may be utilized as the image processing device) may also be implemented in the device with the 3D sensor and imaging device.

In some embodiments, 3D sensor 150 can determine 3D coordinates of each corner of the object in a coordinate space defined with reference to one or more portions of system 140. For example, 3D sensor 150 can determine 3D coordinates of each of eight corners of an object that is at least roughly cuboid in shape within a Cartesian coordinate space defined with an origin at 3D sensor 150. As another example, 3D sensor 150 can determine 3D coordinates of each of eight corners of an object that is at least roughly cuboid in shape within a Cartesian coordinate space defined with respect to conveyor 116 (e.g., with an origin that originates at a center of conveyor 116). As yet another example, 3D sensor 150 can determine 3D coordinates of a bounding box (e.g., having eight corners) of an object that is not a cuboid shape within any suitable Cartesian coordinate space (e.g., defined with respect to conveyor 116, defined with respect to 3D sensor 150, etc.). For example, 3D sensor 150 can identify a bounding box around any suitable non-cuboid shape, such as a polybag, a jiffy mailer, an envelope, a cylinder (e.g., a circular prism), a triangular prism, a quadrilateral prism that is not a cuboid, a pentagonal prism, a hexagonal prism, a tire (or other shape that can be approximated as a toroid), etc. In some embodiments, 3D sensor 150 can be configured to classify an object as a cuboid or non-cuboid shape, and can identify corners of the object for cuboid shapes or corners of a cuboid bounding box for non-cuboid shapes. In some embodiments, 3D sensor 150 can be configured to classify an object as being to a particular class within a group of common objects (e.g., cuboid, cylinder, triangular prism, hexagonal prism, jiffy mailer, polybag, tire, etc.). In some such embodiments, 3D sensor 150 can be configured to determine a bounding box based on the classified shape. In some embodiments, 3D sensor 150 can determine 3D coordinates of non-cuboid shapes, such as soft-sided envelopes, pyramidal shapes (e.g., having four corners), other prisms (e.g., triangular prisms having six corners, quadrilateral prism that is not cuboid, pentagonal prism having ten corners, hexagonal prisms having 12 corners, etc.).

Additionally or alternatively, in some embodiments, 3D sensor 150 can provide raw data (e.g., point cloud data, distance data, etc.) to a control device (e.g., image processing device 132 described below, one or more imaging devices), which can determine the 3D coordinates of one or points of an object.

In some embodiments, a motion measurement device 152 (e.g., an encoder) may be linked to the conveyor 116 and imaging devices 112 to provide electronic signals to the imaging devices 112 and/or image processing device 132 that indicate the amount of travel of the conveyor 116, and the objects 118d, 118e supported thereon, over a known amount of time. This may be useful, for example, in order to coordinate capture of images of particular objects (e.g., objects 118d, 118e), based on calculated locations of the object relative to a field of view of a relevant imaging device (e.g., imaging device(s) 112). In some embodiments, motion measurement device 152 may be configured to generate a pulse count that can be used to identify the position of conveyor 116 along the direction of arrow 154. For example, motion measurement device 152 may provide the pulse count to image processing device 132 for identifying and tracking the positions of objects (e.g., objects 118d, 118e) on conveyor 116. In some embodiments, the motion measurement device 152 can increment a pulse count each time conveyor 116 moves a predetermined distance (pulse count distance) in the direction of arrow 154. In some embodiments, an object's position can be determined based on an initial position, the change in the pulse count, and the pulse count distance.

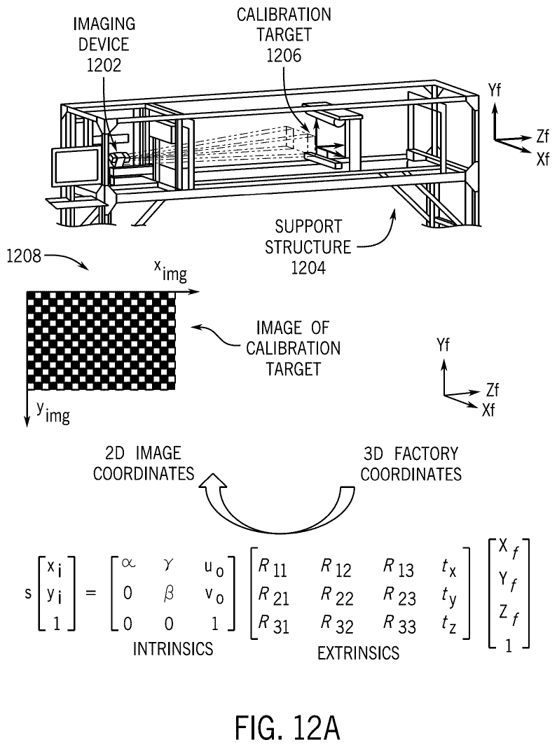

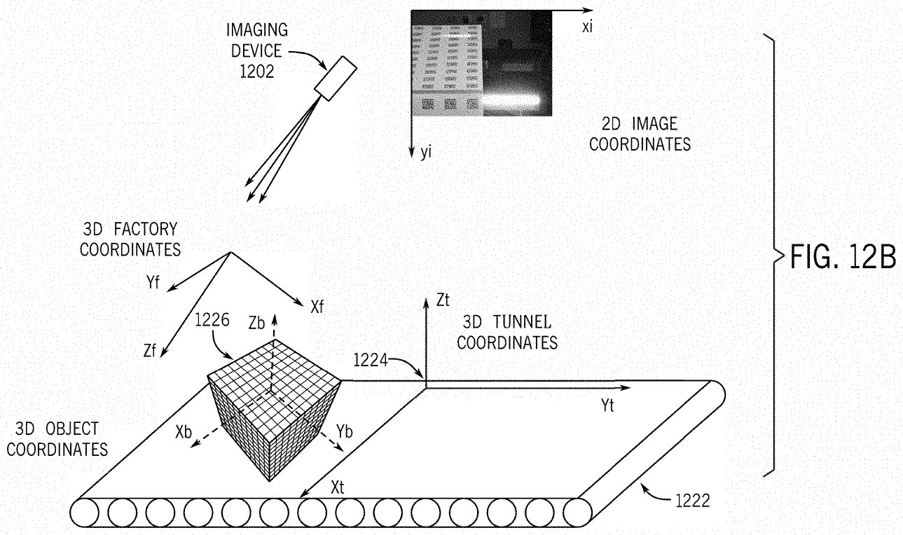

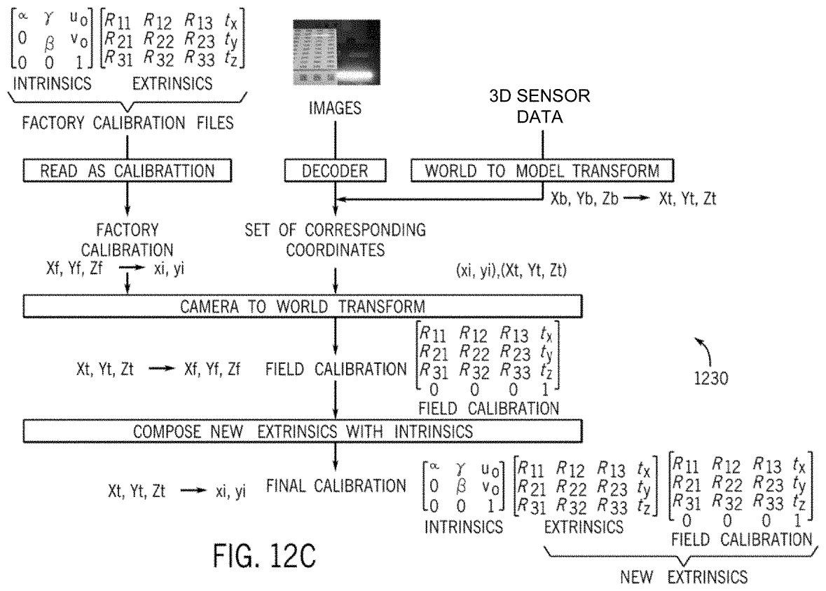

Returning to FIG. 1A, in some embodiments, each imaging device (e.g., imaging devices 112) can be calibrated (e.g., as described below in connection with FIGS. 12A to 12C) to facilitate mapping a 3D location of each corner of an object supported by conveyor 116 (e.g., objects 118) to a 2D location in an image captured by the imaging device. In some embodiments including a steerable mirror(s), such a calibration can be performed with the steerable mirror(s) in a particular orientation.

In some embodiments, image processing device 132 (or a control device) can coordinate operations of various components of system 100. For example, image processing device 132 can cause a 3D sensor (e.g., 3D sensor (or dimensioner) 150 shown in FIG. 1B) to acquire dimensions of an object positioned on conveyor 116 and can cause imaging devices 112 to capture images of each side. In some embodiments, image processing device 132 can control detailed operations of each imaging device, for example, by controlling a steerable mirror, by providing trigger signals to cause the imaging device to capture images at particular times (e.g., when the object is expected to be within a field of view of the imaging devices), etc. Alternatively, in some embodiments, another device (e.g., a processor included in each imaging device, a separate controller device, etc.) can control detailed operations of each imaging device. For example, image processing device 132 (and/or any other suitable device) can provide a trigger signal to each imaging device and/or 3D sensor (e.g., 3D sensor (or dimensioner) 150 shown in FIG. 1B), and a processor of each imaging device can be configured to implement a predesignated image acquisition sequence that spans a predetermined region of interest in response to the trigger. Note that system 100 can also include one or more light sources (not shown) to illuminate surfaces of an object, and operation of such light sources can also be coordinated by a central device (e.g., image processing device 132), and/or control can be decentralized (e.g., an imaging device can control operation of one or more light sources, a processor associated with one or more light sources can control operation of the light sources, etc.). For example, in some embodiments, system 100 can be configured to concurrently (e.g., at the same time or over a common time interval) acquire images of multiple sides of an object, including as part of a single trigger event. For example, each imaging device 112 can be configured to acquire a respective set of one or more images over a common time interval. Additionally or alternatively, in some embodiments, imaging devices 112 can be configured to acquire the images based on a single trigger event. For example, based on a sensor (e.g., a contact sensor, a presence sensor, an imaging device, etc.) determining that object 118 has passed into the FOV of the imaging devices 112, imaging devices 112 can concurrently acquire images of the respective sides of object 118.

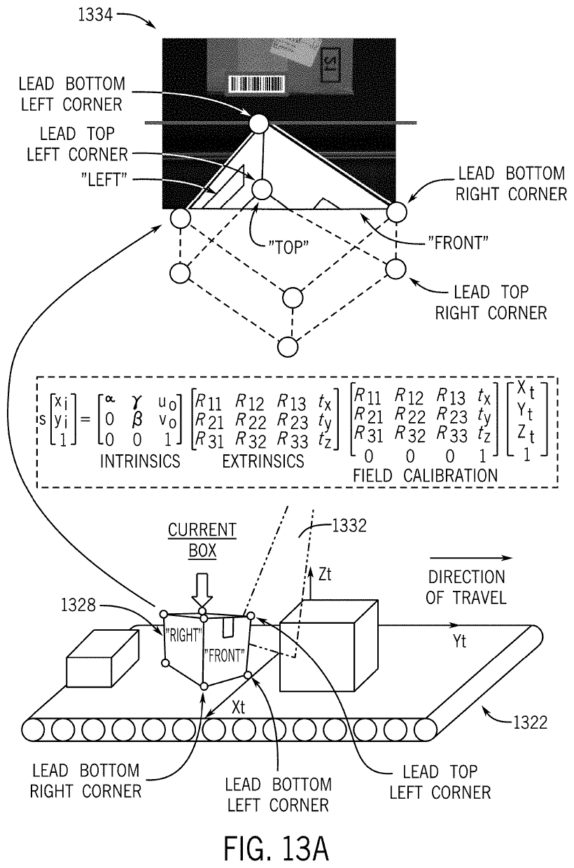

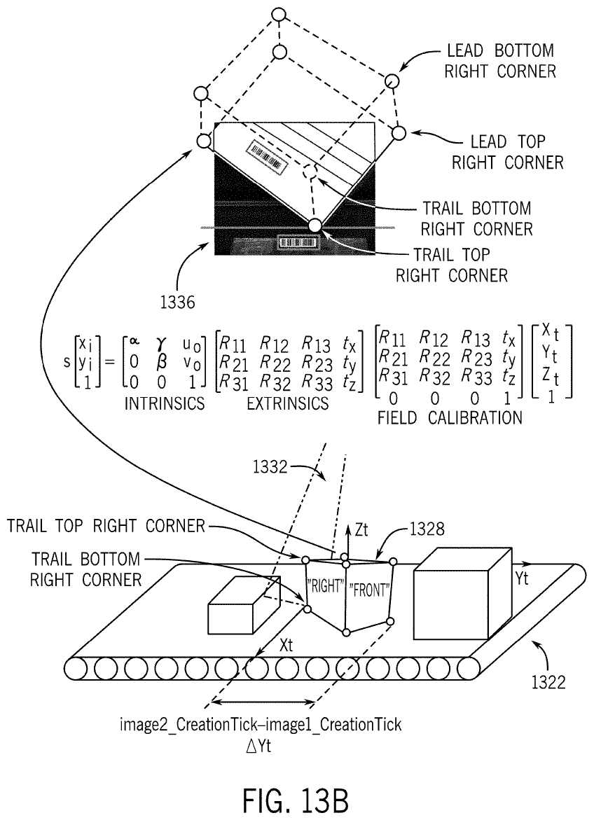

In some embodiments, each imaging device 112 can generate a set of images depicting a FOV or various FOVs of a particular side or sides of an object supported by conveyor 116 (e.g., object 118). In some embodiments, image processing device 132 can map 3D locations of one or more corners of object 118 to a 2D location within each image in set of images output by each imaging device (e.g., as described below in connection with FIGS. 13A and 13B, which show multiple boxes on a conveyor). In some embodiments, image processing device can generate a mask that identifies which portion of an image is associated with each side (e.g., a bit mask with a 1 indicating the presence of a particular side, and a 0 indicating an absence of a particular side) based on the 2D location of each corner. In some embodiments, the 3D locations of one or more corners of a target object (e.g., object 118a) as well as the 3D locations of one or more corners of an object 118c (a leading object) ahead of the target object 118a on the conveyor 116 and/or the 3D locations of one or more corners of an object 118b (a trailing object) behind the target object 118a on the conveyor 116 may be mapped to a 2D location within each image in the set of images output by each imaging device. Accordingly, if an image captures more than one object (118a, 118b, 118c), one or more corners of each object in the image may be mapped to the 2D image.

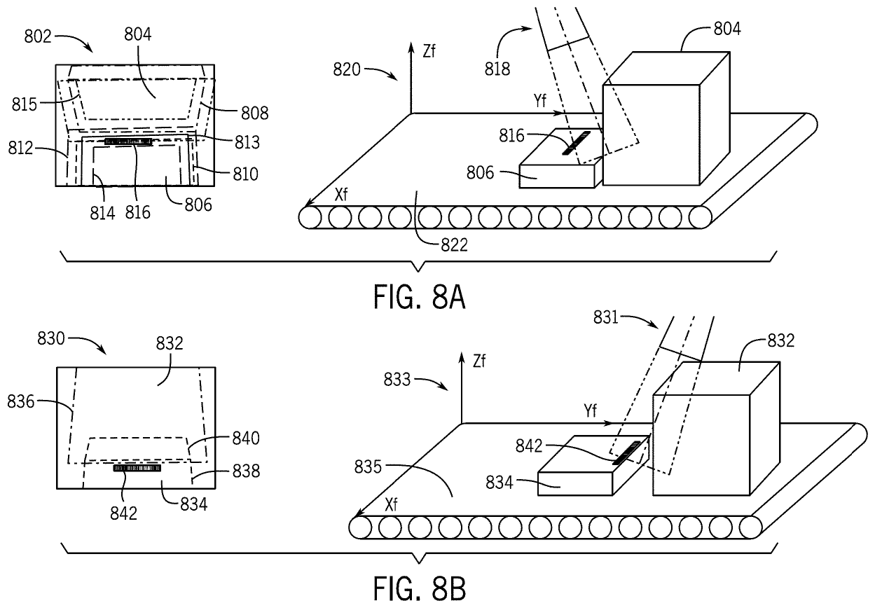

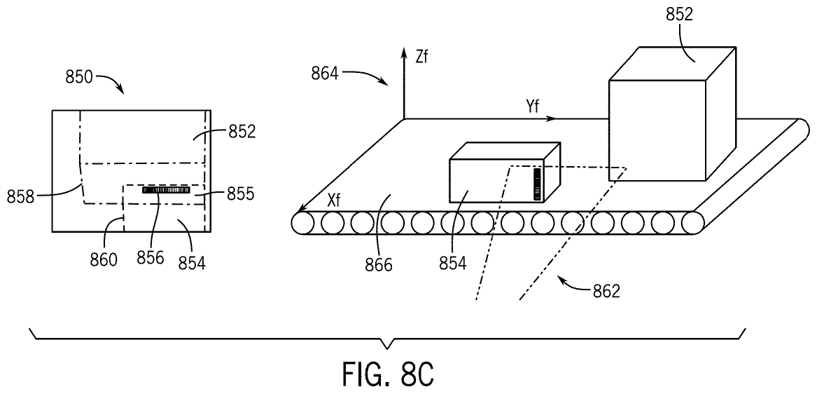

In some embodiments, image processing device 132 can identify which object 118 in an image includes a symbol 120 based on the mapping of the corners of the objects from the 3D coordinate space to the image coordinate space for the image, or any other suitable information that can be representative of a side, such as: multiple planes (e.g., each plane corresponding to a side, and the intersection of multiple planes representing edges and corners); coordinates of a single corner associated with a height, width, and depth; multiple polygons, etc. For example, if a symbol in a captured image falls within the mapped 2D locations of the corners of the object, image processing device 132 can determine that the symbol in the image is on the object. As another example, image processing device 132 can identify which surface of the object includes the symbol based on the 2D locations of the corners of the object. In some embodiments, each surface that is visible from a particular imaging device FOV for a given image may be determined based on which surfaces intersect each other. In some embodiments, the image processing device 132 may be configured to identify when two or more objects (e.g., the surfaces of the objects) overlap in an image (i.e., occlusion). In an example, overlapping objects may be determined based on if surfaces of the objects in an image intersect each other or would intersect given a predefined margin (as discussed further below with respect to FIG. 8A). In some embodiments, if an image including an identified symbol includes two or more overlapping objects, the relative position of the FOV of the imaging device and/or the 2D image data from the images may be used to resolve the overlapping surfaces of the objects. For example, the image data of the image be used to determine edges of one or more objects (or surfaces of the objects) in the image using imaging processing methods, and the determined edges may be used to determine if a symbol is located on a particular object. In some embodiments, image processing system 132 may also be configured to aggregate the symbol assignment results for each symbol in a set of symbols identified in a set of images captured by the imaging devices 112 to determine if there is a conflict between the symbol assignment results for each identified symbol. For example, for a symbol that is identified in more than one image, the symbol may be assigned differently in at least one image in which the symbol appears. In some embodiments, for a symbol with conflicting assignment results, if the assignment results for the symbol include an assignment result for an image without overlapping objects, the image processing system 132 may be configured to select the assignment result for the image without overlapping objects. In some embodiments, a confidence level (or score) may be determined for a symbol assignment for a symbol for a particular image.

As mentioned above, one or more fixed and/or steerable mirrors can be used to redirect a FOV of one or more of the imaging devices, which may facilitate a reduced vertical or lateral distance between imaging devices and objects in tunnel 102. FIG. 2A shows another example of a system for capturing multiple images of each side of an object and assigning a code to the object in accordance with an embodiment of the technology. System 200 includes multiple banks of imaging devices 212, 214, 216, 218, 220, 222 and multiple mirrors 224, 226, 228, 230 in a tunnel arrangement 202. For example, the banks of imaging devices shown in FIG. 2A include a left trail bank 212, a left lead bank 214, a top trail bank 216, a top lead bank 218, a right trail bank 220 and a right lead bank 222. In the illustrated embodiment, each bank 212, 214, 216, 218, 220, 222 includes four imaging devices that are configured to capture images of one or more sides of an object (e.g., object 208a) and various FOVs of the one or more sides of the object. For example, top trail bank 216 and mirror 228 may be configured to capture images of the top and back surfaces of an object using imaging devices 234, 236, 238, and 240. In the illustrated embodiment, the banks of imaging devices 212, 214, 216, 218, 220, 222 and mirrors 224, 226, 228, 230 can be mechanically coupled to a support structure 242 above a conveyor 204. Note that although the illustrated mounting positions of the banks imaging devices 212, 214, 216, 218, 220, 222 relative to one another can be advantageous, in some embodiments, imaging devices for imaging different sides of an object can be reoriented relative to the illustrated positions in FIG. 2A (e.g., imaging devices can be offset, imaging devices can be placed at the corners, rather than the sides, etc.). Similarly, while there can be advantages associated with using four imaging devices per bank that are each configured to acquire image data from one or more sides of an object, in some embodiments, a different number or arrangement of imaging devices, a different arrangement of mirror (e.g., using steerable mirrors, using additional fixed mirrors, etc.) can be used to configure a particular imaging device to acquire images of multiple sides of an object. In some embodiments, an imaging device can be dedicated to acquire images of multiple sides of an object including with overlapping acquisition areas relative to other imaging devices included in the same system.

In some embodiments, system 200 also includes a 3D sensor (or dimensioner) 206 and an image processing device 232. As discussed above, multiple objects 208a, 208b and 208c may be supported in the conveyor 204 and travel through the tunnel 202 along a direction indicated by arrow 210. In some embodiments, each bank of imaging devices 212, 214, 216, 218, 220, 222 (and each imaging device in a bank) can generate a set of images depicting a FOV or various FOVs of a particular side or sides of an object supported by conveyor 204 (e.g., object 208a). FIG. 2B illustrates an example set of images acquired from a bank of imaging devices in the system of FIG. 2A in accordance with an embodiment of the technology. In FIG. 2B, an example set of images 260 captured of an object (e.g., object 208a) on a conveyor using a bank of imaging devices is shown. In the illustrated example, the set of images has been acquired by the top trail bank of imaging devices 216 (shown in FIG. 2A) that is configured to capture images of the top and back surfaces of an object (e.g., object 208a) using imaging devices 234, 236, 238, and 240 and mirror 228. The example set of images 260 is presented as a grid where each column represents images acquired using one of the imaging devices 234, 236, 238, and 240 of the bank of imaging devices. Each row represents an image acquired by each of the imaging devices 234, 236, 238, and 240 at a particular point in time as a first object 262 (e.g., a leading object), a second object 263 (e.g., a target object) and a third object 264 (e.g., a trailing object) travel through the tunnel (e.g., tunnel 202 shown in FIG. 2A). For example, row 266 shows a first image acquired by each imaging device in the bank at a first time point, row 268 shows a second image acquired by each imaging device in the bank at a second time point, row 270 shows a third image acquired by each imaging device in the bank at a third time point, row 272 shows a fourth image acquired by each imaging device in the bank at a fourth time point, and row 272 shows a fifth image acquired by each imaging device in the bank at a fifth time point, In the illustrated example, based on the size of a gap between the first object 262 and the second object 263 and between the second object 263 and the third object 264 on the conveyor, the first object 262 appears in the first image acquired of the second (or target) object 263 and the third object 264 begins to appear in the images acquired of the second (or target) object 263 in the fifth image 274.

In some embodiments, each imaging device (e.g., imaging devices in imaging device banks 212, 214, 216, 218, 220, 222) can be calibrated (e.g., as described below in connection with FIGS. 12A to 12C) to facilitate mapping a 3D location of each corner of an object supported by conveyor 204 (e.g., objects 208) to a 2D location in an image captured by the imaging device.

Note that although FIGS. 1A and 2A depict a dynamic support structure (e.g., conveyor 116, conveyor 204) that is moveable, in some embodiments, a stationary support structure may be used to support objects to be imaged by one or more imaging devices. FIG. 3 shows another example system for capturing multiple images of each side of an object and assigning a symbol to the object in accordance with an embodiment of the technology. In some embodiments, system 300 can include multiple imaging devices 302, 304, 306, 308, 310, and 312, which can each include one or more image sensors, at least one lens arrangement, and at least one control device (e.g., a processor device) configured to execute computational operations relative to the image sensor. In some embodiments, imaging devices 302, 304, 306, 308, 310, and/or 312 can include and/or be associated with a steerable mirror (e.g., as described in U.S. application Ser. No. 17/071,636, filed on Oct. 13, 2020, which is hereby incorporated by reference herein in its entirety). Each of the imaging devices 302, 304, 306, 308, 310, and/or 312 can selectively acquire image data from different fields of view (FOVs), corresponding to different orientations of the associated steerable mirror(s). In some embodiments, system 300 can be utilized to acquire multiple images of each side of an object.

In some embodiments, system 300 can be used to acquire images of multiple objects presented for image acquisition. For example, system 300 can include a support structure that supports each of the imaging devices 302, 304, 306, 308, 310, 312 and a platform 316 configured to support one or more objects 318, 334, 336 to be imaged (note that each object 318, 334, 336 may be associated with one or more symbols, such as a barcode, a QR code, etc.). For example, a transport system (not shown), including one or more robot arms (e.g., a robot bin picker), may be used to position multiple objects (e.g., in a bin or other container) on platform 316. In some embodiments, the support structure can be configured as a caged support structure. However, this is merely an example, and the support structure can be implemented in various configurations. In some embodiments, support platform 316 can be configured to facilitate imaging of the bottom side of one or more objects supported by the support platform 316 (e.g., the side of an object (e.g., object 318, 334, or 336) resting on platform 316). For example, support platform 316 can be implemented using a transparent platform, a mesh or grid platform, an open center platform, or any other suitable configuration. Other than the presence of support platform 316, acquisition of images of the bottom side can be substantially similar to acquisition of other sides of the object.

In some embodiments, imaging devices 302, 304, 306, 308, 310, and/or 312 can be oriented such that a FOV of the imaging device can be used to acquire images of a particular side of an object resting on support platform 316, such that each side of an object (e.g., object 318) placed on and supported by support platform 316 can be imaged by imaging devices 302, 304, 306, 308, 310, and/or 312. For example, imaging device 302 can be mechanically coupled to a support structure above support platform 316, and can be oriented toward an upper surface of support platform 316, imaging device 304 can be mechanically coupled to a support structure below support platform 316, and imaging devices 306, 308, 310, and/or 312 can each be mechanically coupled to a side of a support structure, such that a FOV of each of imaging devices 306, 308, 310, and/or 312 faces a lateral side of support platform 316.

In some embodiments, each imaging device can be configured with an optical axis that is generally parallel with another imaging device, and perpendicular to other imaging devices (e.g., when the steerable mirror is in a neutral position). For example, imaging devices 302 and 304 can be configured to face each other (e.g., such that the imaging devices have substantially parallel optical axes), and the other imaging devices can be configured to have optical axis that are orthogonal to the optical axis of imaging devices 302 and 304.

Note that although the illustrated mounting positions of the imaging devices 302, 304, 306, 308, 310, and 312 relative to one another can be advantageous, in some embodiments, imaging devices for imaging different sides of an object can be reoriented relative the illustrated positions of FIG. 3 (e.g., imaging device can be offset, imaging devices can be placed at the corners, rather than the sides, etc.). Similarly, while there can be advantages (e.g., increased acquisition speed) associated with using six imaging devices that is each configured to acquire imaging data from a respective side of an object (e.g., the six side of object 118), in some embodiments, a different number or arrangement of imaging devices, a different arrangement of mirrors (e.g., using fixed mirrors, using additional moveable mirrors, etc.) can be used to configure a particular imaging device to acquire images of multiple sides of an object. For example, fixed mirrors disposed such that imaging devices 306 and 310 can capture images of a far side of object 318 and can be used in lieu of imaging devices 308 and 312.

In some embodiments, system 300 can be configured to image each of the multiple objects 318, 334, 336 on the platform 316. However, the presence of multiple objects (e.g., objects 318, 334, 336) on the platform 316 during imaging of one of the objects (e.g., object 318) can affect the utility of the resulting images captured by imaging devices 302, 304, 306, 308, 310, and/or 312, including for analysis of symbols on particular objects. For example, when imaging device 306 is used to capture an image of one or more surfaces of object 318, the objects 334 and 336 (e.g., one or more surfaces of objects 334 and 336) may appear in the image and overlap with object 318 in the image captured by imaging device 306. Accordingly, it may be difficult to determine if a detected symbol corresponds to a specific object (i.e., if the symbol should be considered “on” or “off” the object.

In some embodiments, system 300 can include a 3D sensor (or dimensioner) 330. As described above with respect to FIGS. 1A, 1B and 2A, a 3D sensor can be configured to determine dimensions and/or a location of an object supported by support structure 316 (e.g., object 318, 334, or 336). As mentioned above, in some embodiments, 3D sensor 330 can determine 3D coordinates of each corner of the object in a coordinate space defined with reference to one or more portions of system 300. For example, 3D sensor 330 can determine 3D coordinates of each of eight corners of an object that is at least roughly cuboid in shape within a Cartesian coordinate space defined with an origin at 3D sensor 330. As another example, 3D sensor 330 can determine 3D coordinates of each of eight corners of an object that is at least roughly cuboid in shape within a Cartesian coordinate space defined with respect to support platform 316 (e.g., with an origin that originates at a center of support platform 316). As yet another example, 3D sensor 330 can determine 3D coordinates of a bounding box (e.g., having eight corners) of an object that is not a cuboid shape within any suitable Cartesian coordinate space (e.g., defined with respect to support platform 316, defined with respect to 3D sensor 330, etc.). For example, 3D sensor 330 can identify a bounding box around any suitable non-cuboid shape, such as a polybag, a jiffy mailer, an envelope, a cylinder (e.g., a circular prism), a triangular prism, a quadrilateral prism that is not a cuboid, a pentagonal prism, a hexagonal prism, a tire (or other shape that can be approximated as a toroid), etc. In some embodiments, 3D sensor 330 can be configured to classify an object as a cuboid or non-cuboid shape, and can identify corners of the object for cuboid shapes or corners of a cuboid bounding box for non-cuboid shapes. In some embodiments, 3D sensor 330 can be configured to classify an object as being to a particular class within a group of common objects (e.g., cuboid, cylinder, triangular prism, hexagonal prism, jiffy mailer, polybag, tire, etc.). In some such embodiments, 3D sensor 330 can be configured to determine a bounding box based on the classified shape. In some embodiments, 3D sensor 330 can determine 3D coordinates of non-cuboid shapes, such as soft-sided envelopes, pyramidal shapes (e.g., having four corners), other prisms (e.g., triangular prisms having six corners, quadrilateral prism that is not cuboid, pentagonal prism having ten corners, hexagonal prisms having 12 corners, etc.).

Additionally or alternatively, in some embodiments, 3D sensor (or dimensioner) 330 can provide raw data (e.g., point cloud data, distance data, etc.) to a control device (e.g., image processing device 332, one or more imaging devices), which can determine the 3D coordinates of one or points of an object.

In some embodiments, each imaging device (e.g., imaging devices 302, 304, 306, 308, 310, and 312) can be calibrated (e.g., as described below in connection with FIGS. 12A to 12C) to facilitate mapping a 3D location of each corner of an object supported by support platform 316 (e.g., object 318) to a 2D location in an image captured by the imaging device with the steerable mirror in a particular orientation.

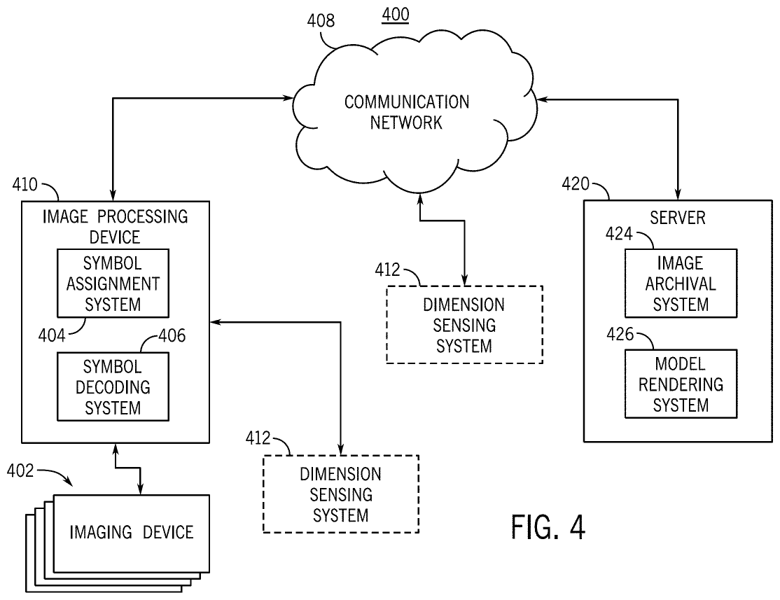

In some embodiments, an image processing device 332 can coordinate operations of imaging devices 302, 304, 306, 308, 310, and/or 312 and/or can perform image processing tasks as described above in connection with image processing device 132 of FIG. 1A and/or image processing device 410 discussed below in connection with FIG. 4. For example, image processing device 332 can identify which object in an image includes a symbol based on, for example, the mapping of the 3D corners of the objects from 3D coordinate space to the 2D image coordinate space for an image associated with the symbol.

FIG. 4 shows an example 400 of a system for generating images of multiple sides of an object in accordance with an embodiment of the technology. As shown in FIG. 4, an image processing device 410 (e.g., image processing device 132) can receive images and/or information about each image (e.g., 2D locations associated with the image) from multiple imaging devices 402 (e.g., imaging devices 112a, 112b and 112c described above in connection with FIG. 1A, imaging devices in imaging device banks 212, 214, 216, 218, 220, 222 described above in connection with FIGS. 2A and 2B, and/or imaging device 302, 304, 306, 308, 310, 312 described above in connection with FIG. 3). Additionally, image processing device 410 can receive dimension data about an object imaged by imaging devices 402 from a dimension sensing system 412 (e.g., 3D sensor (or dimensioner) 150, 3D sensor (or dimensioner) 206, 3D sensor (or dimensioner) 330), which may be locally connected to image processing device 410 and/or connected via a network connection (e.g., via a communication network 408). Image processing device 410 can also receive input from any other suitable motion measurement device, such as an encoder (not shown) configured to output a value indicative of movement of a conveyor over a particular period of time which can be used to determine a distance that an object has traveled (e.g., between when dimensions were determined and when each image of the object is generated). Image processing device 410 can also coordinate operation of one or more other devices, such as one or more light sources (not shown) configured to illuminate an object (e.g., a flash, a flood light, etc.)

In some embodiments, image processing device 410 can execute at least a portion of a symbol assignment system 404 to assign a symbol to an object using a group of images associated with the sides of the object. Additionally or alternatively, image processing device 410 can execute at least a portion of a symbol decoding system 406 to identify and/or decode symbols (e.g., barcodes, QR codes, text, etc.) associated with an object imaged by imaging devices 402 using any suitable technique or combination of techniques.

In some embodiments, image processing device 410 can execute at least a portion of symbol assignment system 404 to more efficiently assign a symbol to an object using mechanisms described herein.

In some embodiments, image processing device 410 can communicate image data (e.g., images received from the imaging device 402) and/or data received from dimension sensing system 412 to a server 420 over communication network 408, which can execute at least a portion of an image archival system 424 and/or a model rendering system 426. In some embodiments, server 420 can use image archival system 424 to store image data received from image processing deice 410 (e.g., for retrieval and inspection if the object is reported damaged, for further analysis such as an attempt to decode a symbol that could not be read by symbol decoding system 406 or to extract information from text associated with the object). Additionally or alternatively, in some embodiments, server 420 can use model rendering system 426 to generate 3D models of objects for presentation to a user.

In some embodiments, image processing device 410 and/or server 420 can be any suitable computing device or combination of devices, such as a desktop computer, a laptop computer, a smartphone, a tablet computer, a wearable computer, a server computer, a virtual machine being executed by a physical computing device, etc.

In some embodiments, imaging devices 402 can be any suitable imaging devices. For example, each including at least one imaging sensor (e.g., a CCD image sensor, a CMOS image sensor, or other suitable sensor), at least one lens arrangement, and at least one control device (e.g., a processor device) configured to execute computational operations relative to the imaging sensor. In some embodiments, a lens arrangement can include a fixed-focus lens. Additionally or alternatively, a lens arrangement can include an adjustable focus lens, such as a liquid lens or a known type of mechanically adjusted lens. Additionally, in some embodiments, imaging devices 302 can include a steerable mirror that can be used to adjust a direction of a FOV of the imaging device. In some embodiments, one or more imaging devices 402 can include a light source(s) (e.g., a flash, a high intensity flash, a light source described in U.S. Patent Application Publication No. 2019/0333259, etc.) configured to illuminate an object within a FOV.

In some embodiments, dimension sensing system 412 can be any suitable dimension sensing system. For example, dimension sensing system 412 can be implemented using a 3D camera (e.g., a structured light 3D camera, a continuous time of flight 3D camera, etc.). As another example, dimension sensing system 412 can be implemented using a laser scanning system (e.g., a LiDAR system). In some embodiments, dimension sensing system 412 can generate dimensions and/or 3D locations in any suitable coordinate space.

In some embodiments, imaging devices 402 and/or dimension sensing system 412 can be local to image processing device 410. For example, imaging devices 402 can be connected to image processing device 410 by a cable, a direct wireless link, etc. As another example, dimension sensing system 412 can be connected to image processing device 410 by a cable, a direct wireless link, etc. Additionally or alternatively, in some embodiments, imaging devices 402 and/or dimension sensing system 412 can be located locally and/or remotely from image processing device 410, and can communicate data (e.g., image data, dimension and/or location data, etc.) to image processing device 410 (and/or server 420) via a communication network (e.g., communication network 408). In some embodiments, one or more imaging devices 402, dimension sensing system 412, image processing device 410, and/or any other suitable components can be integrated as a single device (e.g., within a common housing).

In some embodiments, communication network 408 can be any suitable communication network or combination of communication networks. For example, communication network 408 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 408 can be a local area network (LAN), a wide area network (WAN), a public network (e.g., the Internet), a private or semi-private network (e.g., a corporate or university intranet), any other suitable type of network, or any suitable combination of networks. Communications links shown in FIG. 4 can each be any suitable communications link or combination of communications links, such as wired links, fiber optic links, Wi-Fi links, Bluetooth links, cellular links, etc.

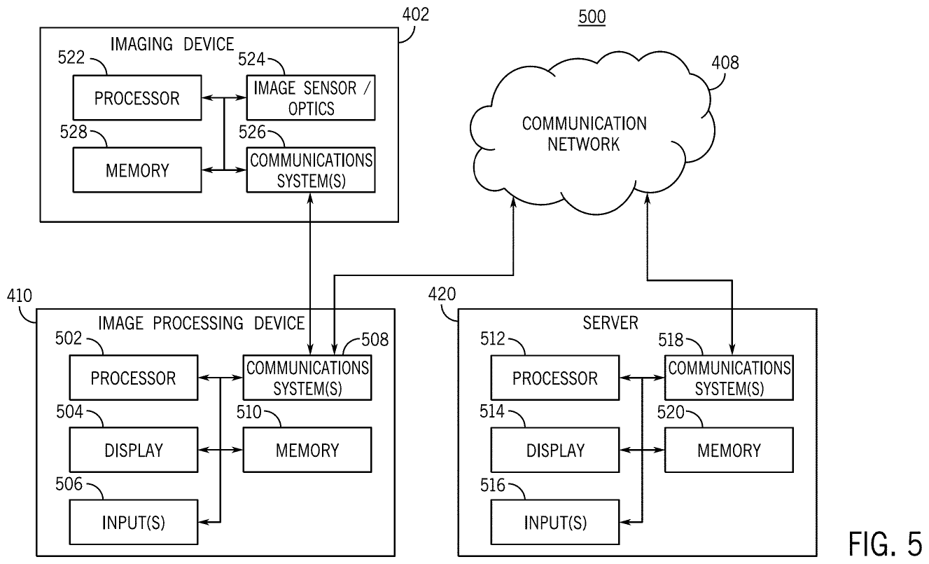

FIG. 5 shows an example 500 of hardware that can be used to implement an image processing device, a server, and an imaging device shown in FIG. 4 in accordance with some embodiments of the disclosed subject matter. FIG. 5 shows an example 500 of hardware that can be used to implement image processing device 410, server 420, and/or imaging device 402 in accordance with some embodiments of the disclosed subject matter. As shown in FIG. 5, in some embodiments, image processing device 410 can include a processor 502, a display 504, one or more inputs 506, one or more communication systems 508, and/or memory 510. In some embodiments, processor 502 can be any suitable hardware processor or combination of processors, such as a central processing unit (CPU), a graphics processing unit (GPU), an application specific integrated circuit (ASIC), a field-programmable gate array (FPGA), etc. In some embodiments, display 504 can include any suitable display devices, such as a computer monitor, a touchscreen, a television, etc. In some embodiments, display 504 can be omitted. In some embodiments, inputs 506 can include any suitable input devices and/or sensors that can be used to receive user input, such as a keyboard, a mouse, a touchscreen, a microphone, etc. In some embodiments, inputs 506 can be omitted.

In some embodiments, communications systems 508 can include any suitable hardware, firmware, and/or software for communicating information over communication network 408 and/or any other suitable communication networks. For example, communications systems 508 can include one or more transceivers, one or more communication chips and/or chip sets, etc. In a more particular example, communications systems 408 can include hardware, firmware and/or software that can be used to establish a Wi-Fi connection, a Bluetooth connection, a cellular connection, an Ethernet connection, etc.

In some embodiments, memory 510 can include any suitable storage device or devices that can be used to store instructions, values, etc., that can be used, for example, by processor 502 to perform a computer vision task, to present content using display 504, to communicate with server 420 and/or imaging device 402 via communications system(s) 508, etc. Memory 510 can include any suitable volatile memory, non-volatile memory, storage, or any suitable combination thereof. For example, memory 510 can include random access memory (RAM), read-only memory (ROM), electronically-erasable programmable read-only memory (EEPROM), one or more flash drives, one or more hard disks, one or more solid state drives, one or more optical drives, etc. In some embodiments, memory 510 can have encoded thereon a computer program for controlling operation of image processing device 410. For example, in such embodiments, processor 502 can execute at least a portion of the computer program to assign symbols to an object, to transmit image data to server 420, to decode one or more symbols, etc. As another example, processor 502 can execute at least a portion of the computer program to implement symbol assignment system 404 and/or symbol decoding system 406. As yet another example, processor 502 can execute at least a portion of one or more of process(es) 600, 630, and/or 660 described below in connection with FIGS. 6A, 6B, and/or 6C.

In some embodiments, server 420 can include a processor 512, a display 514, one or more inputs 516, one or more communications systems 518, and/or memory 520. In some embodiments, processor 512 can be any suitable hardware processor or combination of processors, such as a CPU, a GPU, an ASIC, an FPGA, etc. In some embodiments, display 514 can include any suitable display devices, such as a computer monitor, a touchscreen, a television, etc. In some embodiments, display 514 can be omitted. In some embodiments, inputs 516 can include any suitable input devices and/or sensors that can be used to receive user input, such as a keyboard, a mouse, a touchscreen, a microphone, etc. In some embodiments, inputs 516 can be omitted.

In some embodiments, communications systems 518 can include any suitable hardware, firmware, and/or software for communicating information over communication network 408 and/or any other suitable communication networks. For example, communications systems 518 can include one or more transceivers, one or more communication chips and/or chip sets, etc. In a more particular example, communications systems 518 can include hardware, firmware and/or software that can be used to establish a Wi-Fi connection, a Bluetooth connection, a cellular connection, an Ethernet connection, etc.

In some embodiments, memory 520 can include any suitable storage device or devices that can be used to store instructions, values, etc., that can be used, for example, by processor 512 to present content using display 514, to communicate with one or more image processing devices 410, etc. Memory 520 can include any suitable volatile memory, non-volatile memory, storage, or any suitable combination thereof. For example, memory 520 can include RAM, ROM, EEPROM, one or more flash drives, one or more hard disks, one or more solid state drives, one or more optical drives, etc. In some embodiments, memory 520 can have encoded thereon a server program for controlling operation of server 420. For example, in such embodiments, processor 512 can receive data from image processing device 410 (e.g., values decoded from a symbol associated with an object, etc.), image devices 402, and/or dimension sensing system 412, and/or store symbol assignments. As another example, processor 512 can execute at least a portion of the computer program to implement image archival system 424 and/or model rendering system 426. As yet another example, processor 512 can execute at least a portion of process(es) 600, 630, and/or 660 described below in connection with FIGS. 6A, 6B, and/or 6C. Note that, although not shown in FIG. 5, server 420 can implement symbol assignment system 404 and/or symbol decoding system 406 in addition to, or in lieu of, such systems being implemented using image processing device 410.

FIG. 6A illustrates a process 600 for assigning a code to an object using images of multiple sides of the object in accordance with an embodiment of the technology. At block 602, process 600 can receive a set of identified symbols from a set of one or more images. For example, as mentioned above the images acquired of one or more objects using, for example, system 100, 200, or 300 may be analyzed to identify any symbols in each image and to decode the identified symbols. In some embodiments, a set (e.g., a list) of identified symbols may be generated and each identified symbol may be associated with the image in which the symbol was identified, the imaging device used to capture the image and a 2D location of the symbol in the image in which it was identified. At block 604, for each symbol in the set of identified symbols, process 600 can receive 3D locations of points corresponding to a 3D pose (e.g., corresponding to corners) of an object in tunnel coordinate space associated with a device used to determine the 3D locations and/or defined based on a physical space (e.g., a conveyor, such as conveyor 116 of FIG. 1A, conveyor 204 of FIG. 2A, or support platform 316 in FIG. 3). For example, as described above in connection with FIGS. 1B, 2A and 3, a 3D sensor (e.g., 3D sensor (or dimensioner) 150, 206, 330) can determine a location of the corners of an object at a particular point in time when the corresponding image is captured and/or when the object is located at a particular location (e.g., a location associated with the 3D sensor). Accordingly, in some embodiments, the 3D location of the corners is associated with the particular point in time or particular location at which the image was captured by an imaging device. As another example, a 3D sensor (e.g., 3D sensor (or dimensioner) 150) can generate data indicative of a 3D pose of an object, and can provide the data (e.g., point cloud data, a height of the object, a width of the object, etc.) to process 600, which can determine a 3D location of one or more points of the object. In some embodiments, the 3D location of points corresponding to corners of the object can be information indicative of a 3D pose of the object. For example, the 3D positioning of the object in a coordinate space can be determined based on the 3D locations of points in that coordinate space corresponding to corners of the object. While the following description of FIGS. 6A-11 refers to locations of points corresponding to corners of an object, it should be understood that other information indicative of a 3D pose (e.g., point cloud data, a height of an object, etc.) may be used.

In some embodiments, the 3D locations can be locations in a coordinate space associated with a device that measured the 3D locations. For example, as described above in connection with FIGS. 1B and 2A, the 3D locations can be defined in a coordinate space associated with the 3D sensor (e.g., in which the origin is located at the 3D sensor (or dimensioner)). As another example, as described above in connection with FIGS. 1B and 2A, the 3D locations can be defined in a coordinate space associated with a dynamic support structure (e.g., a conveyor, such as conveyor 116, 204). In such an example, the 3D locations measured by the 3D sensor can be associated with a particular time at which a measurement was taken, and/or a particular location along the dynamic support structure. In some embodiments, a 3D location of the corners of the object when an image of the object was captured can be derived based on the initial 3D locations and a time that has elapsed since the measurement was taken and a speed of the object during the elapsed time. Additionally or alternatively, a 3D location of the corners of the object when an image of the object was captured can be derived based on the initial 3D locations and distance that the object has traveled since the measurement was taken (e.g., recorded using a motion measurement device, such as motion measurement device 152 shown in FIG. 1B, that directly measures movement of the conveyor).

In some embodiments, process 600 can receive raw data indicative of a 3D pose of the object (e.g., point cloud data, a height of the object, a width of the object, etc.), and can determine the 3D pose of the object and/or the location of one or more features (e.g., corners, edges, surfaces, etc.) of the object using the raw data. For example, process 600 can utilize techniques described in U.S. Pat. No. 11,335,021, issued May 17, 2022, which is hereby incorporated herein by reference in its entirety, to determine the 3D pose of the object (e.g., for cuboidal objects, polybags, envelopes, jiffy mailers, and objects that can be approximated as cuboidal) and/or the location of one or more features of the object from raw data indicative of the 3D pose of the object. As another example, process 600 can utilize techniques described in U.S. Patent Application Publication No. 2022/0148153, published May 12, 2022, which is hereby incorporated herein by reference in its entirety, to determine the 3D pose of the object (e.g., for cylindrical and spherical objects) and/or the location of one or more features of the object from raw data indicative of the 3D pose of the object.

At block 606, for each object in the image associated with the symbol, process 600 can map each 3D location of points(s) corresponding to the 3D pose (e.g., each 3D location of a corner) of the object in the tunnel coordinate space to a 2D location in image coordinate space for the imaging device (and/or FOV angle) associated with the image. For example, as described below in connection with FIGS. 12A to 13B, the 3D location of each corner can be mapped to a 2D location in an image captured by an imaging device with a particular FOV at a particular time. As mentioned above, each imaging device can be calibrated (e.g., as described below in connection with FIGS. 12A to 12C) to facilitate mapping the 3D location of each corner of an object to a 2D location in the image associated with the symbol. Note that in many images each corner may fall outside of the image (e.g., as shown in set of images 260), and in other images one or more corners may fall outside of the image, while one or more corners fall within the image. In some embodiments, for an image that includes more than one object, the 3D corners for each object in the image (e.g., a target object and one or more of a leading object and a trailing object) may be mapped to a 2D location in the image coordinate space for the image using the process described in blocks 604-606. In some embodiments, the dimensioning data for each object (e.g., a leading object, a target object, a trailing object) is stored in, for example, a memory.

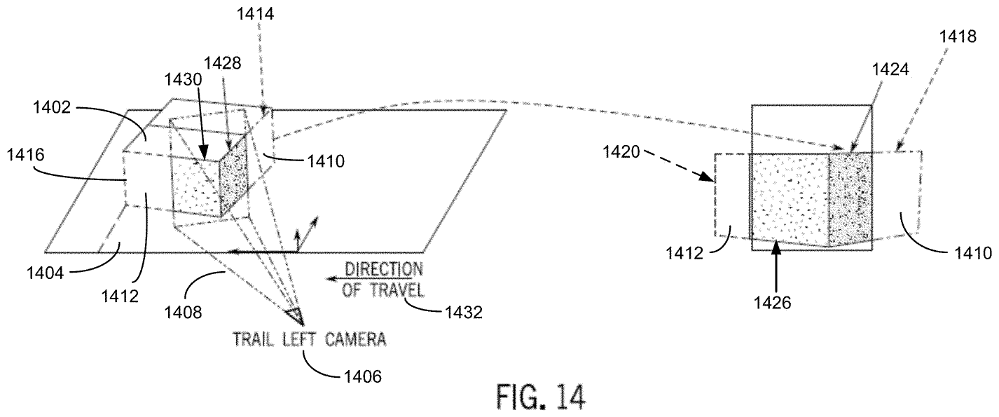

At block 608, process 600 can associate a portion of each image with a surface of the object based on the 2D location of the point(s), for example corresponding to the corners of the object, with respect to the image (e.g., without analyzing the image content). For example, process 600 can identify a portion of a particular image as corresponding to a first side of an object (e.g., a top of the object), and another portion of the particular image as corresponding to a second side of the object (e.g., a front of the object). In some embodiments, process 600 can use any suitable technique or combination of techniques to identify which portion (e.g., which pixels) of an image corresponds to a particular side of an object. For example, process 600 can draw lines (e.g., polylines) between the 2D locations associated with corners of the object, and can group pixels that fall within the confines of the lines (e.g., polylines) associated with a particular side of the object. In some embodiments, a portion of the image may be associated with a surface of each object in the image. In some embodiments, the 2D location of the corners and the determined surfaces of each object may be used to identify when two or more objects overlap in an image (i.e., occlusion). For example, which surfaces are visible from a particular imaging device FOV for a given image may be determined based on which of the determined surfaces intersect with one another. FIG. 14 illustrates an example of determining visible surfaces of one or more objects in an image in accordance with an embodiment. For each surface of an object 1402 positioned on a support structure 1404 (e.g., a conveyor or platform), the surface normal and its corresponding 3D points along with the optical axis and FOV 1408 of an imaging device 1406 may be used to identify the surfaces of the object 1402 that can possibly be visible from the imaging device 1406. In the example illustrated in FIG. 14, a back surface 1410 and a left surface 1412 of the object 1402 may be visible from a trail left imaging device 1406 (e.g., in the FOV 1408 of imaging device 1406) as the object 1402 moves along a direction of travel 1432 . For each of the surfaces 1410, 1412 that may possibly be visible from the imaging device 1406, the polyline created by the vertices of the full surface in world 3D may be mapped to the 2D image using the calibration of the imaging device 1406 (e.g., as described above with respect to block 606). For example, for the back surface 1410 of the object 1402, the polyline 1414 created by the vertices of the full surface in world 3D may be mapped to the 2D image and for the left surface 1412 of the object 1402, the polyline 1416 created by the vertices of the full surface in world 3D may be mapped to the 2D image. The resulting polyline of the vertices of the full surface in the 2D image may be, for example, fully inside the 2D image, partially inside the 2D image, or fully outside the 2D image. For example, in FIG. 14, the polyline 1418 of the full back surface 1410 in the 2D image is partially inside the 2D image and the polyline 1420 of the full left surface 1412 in the 2D image is partially inside the 2D image. The intersection of the polyline 1418 of the full back surface 1410 with the 2D image may be determined to identify visible surface region 1424 in image 2D for the back surface 1401 and the intersection of the polyline 1420 of the full left surface 1412 with the 2D image may be determined to identify the visible surface region 1426 in image 2D for the left surface 1412. The visible surface regions in image 2D 1424, 1426 are the portions of the 2D image that correspond to each visible surface, for example, back surface 1410 and left surface 1412, respectively. In some embodiments, if needed, the visible surface region 1424 in 2D for the back surface 1410 and the visible surface region 1426 in 2D for the left surface 1412 may be mapped back to world 3D to determine the visible surface region in 3D 1428 for the back surface 1410 and the visible surface region in 3D 1430 for the left surface 1412. For example, the visible surface regions identified in 2D may be mapped back to world 3D (or box 3D or the coordinate space of the object) to perform additional analysis such as, for example, determining if the placement of a symbol on the object is correct, or to do metric measurements on the location of a symbol with respect to the surface of the object which can be critical to identify vendor compliance with specifications on where to put symbols and labels on an object.

In order to address errors in one or more mapped edges (e.g., the boundary determined from mapping the 3D location of point(s), for example, corresponding to corners, of an object) of one or more of the objects or surfaces of the objects in the image, in some embodiments, the one or more mapped edges may be determined and refined using the content of image data for the image and image processing techniques used to generate the image. Errors in the mapped edges may be caused by, for example, irregular motion of an object (e.g., an object rocking as it translates on a conveyor), errors in 3D sensor data (or dimensioner data, errors in calibration, etc. In some embodiments, the image of the object may be analyzed to further refine an edge based on the proximity of the symbol to the edge. Accordingly, the image data associated with the edge may be used to determine where the edge should be located.

For each image, a symbol identified in the image may be assigned to an object in the image and/or a surface of the object at blocks 610 and 612. Although blocks 610 and 612 are illustrated in a particular order, in some embodiments, blocks 610 and 612 may be executed in a different order than illustrated in FIG. 6A, or may be bypassed. In some embodiments, at block 610, for each image a symbol identified in the image may be assigned to an object in the image based on the 2D location of the point(s), for example corresponding to the corners of one or more objects in the image. Accordingly, the symbol may be associated with a particular object in the image, e.g., the object in the image to which the symbol is affixed. For example, it may be determined whether the location of the symbol (e.g. the 2D location of the symbol in the associated image) is inside or outside of boundaries defined by the 2D location of the corners of an object. The identified symbol may be assigned to (or associated with) an object if, for example, the location of the symbol is inside the boundaries defined by the 2D location of the corners of the object.

In some embodiments, at block 612, a symbol identified in the image may be assigned to a surface of an object in the image based on the 2D location of the point(s), for example corresponding to the corners of the object, and the one or more surfaces of the object determined at block 610. Accordingly, the symbol may be associated with a particular surface of the object in the image, e.g., the surface of the object to which the code is affixed. For example, it may be determined whether the location of the symbol is inside or outside of boundaries defined by a surface of an object. The identified symbol may be assigned to (or associated with) a surface of the object if, for example, the location of the symbol is inside the boundaries defined by one of the determined surfaces of the object. In some embodiments, the symbol assignment to a surface at block 612 may be performed after the symbol has been assigned to an object at block 610. In other words, the symbol may first be assigned to an object at block 610 and then assigned to a surface of the assigned object at block 612. In some embodiments, the symbol may be assigned directly to a surface at block 612 without first assigning the symbol to an object. In such embodiments, the object to which the symbol is affixed can be determined based on the assigned surface.

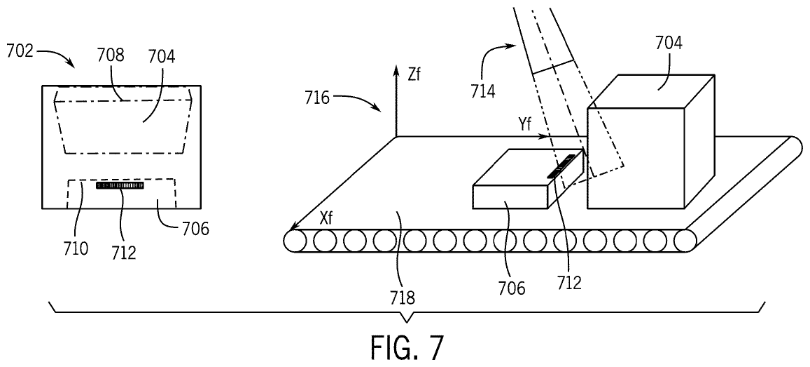

In some embodiments, an image associated with an identified symbol may include two or more objects (or surfaces of the objects) that do not overlap. FIG. 7 illustrates an example of an image with two objects where at least one object includes a symbol to be assigned in accordance with an embodiment of the technology. In FIG. 7, an example image 702 of two objects 704 and 706 is shown along with a corresponding 3D coordinate space 716 (e.g., associated with a support structure such as conveyor 718) and FOV 714 of an imaging device (not shown) used to capture the image 802. As discussed above, the 3D locations of the corners of the first object 704 and the second object 706 may be mapped to the 3D image coordinate space and used to determine a boundary 708 (e.g., polylines) of the first object 704 and a boundary 710 (e.g., polylines) of the second object 706. In FIG. 7, the 2D location of a symbol 712 falls within the boundary 710 of a surface of object 706. Accordingly, the symbol 712 may be assigned to the object 706.

In some embodiments, an image associated with an identified symbol may include two or more objects (or surfaces of the objects) that do overlap. FIGS. 8A-8C illustrate examples of an image with two objects having overlapping surfaces where at least one object has a symbol to be assigned in accordance with an embodiment of the technology. In some embodiments, if at least one surface of each of two objects in an image intersect, the intersecting surfaces are determined to be overlapping (e.g., as shown in FIGS. 8B and 8C). In some embodiments, if there is no actual overlap of the surfaces of the two objects (i.e., the surfaces do not intersect (e.g., as shown in FIG. 8A)), the boundaries (e.g., polylines) of the two objects may still be close enough so that any error in locating or mapping the boundaries of the objects may result in an incorrect symbol assignment. In such embodiments, a margin may be provided around the mapped edges of each object that represents an uncertainty in where the boundaries are located due to errors (e.g., caused by irregular motion of an object, errors in dimension data, error in calibration). Objects (or surfaces of objects) may be defined as overlapping if the boundaries of the objects including the margins intersect. In FIG. 8A, an example image 802 of two objects 804 and 806 is shown along with a corresponding 3D coordinate space 820 (e.g., associated with a support structure such as conveyor 822) and FOV 818 of an imaging device (not shown) used to capture image 802. In FIG. 8A, a first object 804 (or surface of the first object) in the image 802 has a boundary 808 and a second object 806 (or surface of the second object) in the image 802 has a boundary 810. A margin around the boundary 808 of the first object 804 is defined between lines 813 and 815. A margin around the boundary 810 of the second object 806 is defined between lines 812 and 814. While the boundary 806 and the boundary 810 are in close proximity, they do not overlap. However, the margin for the first object 804 (defined by lines 813 and 815) and the margin for the second object 806 (defined by lines 812 and 814) do overlap (or intersect). Accordingly, the first object 804 and the second object 806 may be determined to be overlapping. In some embodiments, the identified symbol 816 may be initially assigned to a surface of object 806 (e.g., at blocks 610 and 612 of FIG. 6A), however, the overlapping surfaces may be further resolved using additional techniques (e.g., using the process of blocks 614 and 616 of FIG. 6A and FIG. 6B).

In another example, in FIG. 8B an example image 830 of two overlapping objects 832 and 834 (e.g., two overlapping surfaces of objects) is shown along with a corresponding 3D coordinate space 833 (e.g., associated with a support structure such as conveyor 835) and FOV 831 of an imaging device (not shown) used to capture the image 830. As discussed above, the 3D locations of the corners of the first object 832 and the second object 824 may be mapped to the 2D image coordinate space and used to determine a boundary 836 (e.g., polylines) of the first object 832 and a boundary 838 (e.g., polylines) of the second object 834. In FIG. 8B, the boundary 836 of the first object 832 and the boundary 838 of the second object 834 overlap in an overlap region 840. The 2D location of an identified symbol 842 falls within the boundary 838 of a surface of object 834. In addition, the 2D location of the symbol 842 is within a margin (not shown) of boundary 836 of a surface of object 832, however, the symbol 842 does not fall within the overlap region 840 (e.g., as the result of error in mapping or locating the boundaries). Accordingly, the symbol 842 may be initially assigned to the object 834 (e.g., at blocks 610 and 612 of FIG. 6A), however, the ambiguity that may be caused from potential marginal errors, the overlapping surfaces may be further resolved using additional techniques (e.g., using the process of blocks 614 and 616 of FIG. 6A and FIG. 6B.

In another example, in FIG. 8C an example image 850 of two overlapping objects 852 and 854 (e.g., two overlapping surfaces of objects) is shown along with a corresponding 3D coordinate space 864 (e.g., associated with a support structure such as conveyor 866) and FOV 862 of an imaging device (not shown) used to capture the image 850. As discussed above, the 3D locations of the corners of the first object 852 and the second object 854 may be mapped to the 3D image coordinate space and used to determine a boundary 858 (e.g., polylines) of the first object 852 and a boundary 860 (e.g., polylines) of the second object 854. In FIG. 8C, a surface of the first object 852 and a surface of the second object 854 overlap. The 2D location of an identified symbol 856 is within the boundaries of overlapping surfaces of objects 852 and 854 (e.g., overlap region 855) and may be initially assigned to the object 854 (e.g., at blocks 610 and 612 of FIG. 6A), however, the overlapping surfaces may be further resolved using additional techniques (e.g., using the process of blocks 614 and 616 of FIG. 6A and FIG. 6B.

Returning to FIG. 6A, at block 614, if the image associated with the symbol includes overlapping surfaces between two or more objects in the image, the overlapping surfaces may be resolved to identify or confirm the initial symbol assignment, for example, using a process as discussed further below in connection with FIG. 6B. At block 614, if the image associated with the decoded symbol does not have overlapping surfaces between two or more objects in the image, a confidence level (or score) may be determined for the symbol assignment at block 617. In some embodiments, the confidence level (or score) may fall within a range of values such as, for example, between 0 and 1 or between 0% and 100%. For example, a confidence level of 40% may indicate a 40% chance the symbol is affixed to an object and/or surface and a 60% chance the symbol is not affixed to the object and/or surface. In some embodiments, the confidence level may be a normalized measure of how far the 2D location of the symbol is from the boundaries defined by the 2D location of the points (e.g., corresponding to the corners of an object) of the object or from the boundaries defined by a surface of the object. For example, the confidence level may be higher when the 2D location of the symbol in the image is farther from the boundaries defined by the 2D locations of the points or defined by a surface and lower when the 2D location of the symbol when the 2D location of the symbol is very close to the boundaries defined by the 2D locations of the points or defined by a surface. In some embodiments, the confidence level may also be based on one or more additional factors including, but not limited to, whether the 2D location of the symbol is inside or outside the boundaries defined by the 2D location of the points (e.g., corresponding to corners) of the object or defined by the surface of the object, a ratio of the distance of the 2D location of the symbol from the boundaries of different objects in the FOV, whether there are overlapping objects in the image (as discussed further below with respect to FIG. 6B), and on an image processing technique used to refine one or more edges of an object or surface of an object and the confidence in the technique to find the correct edge location based on the image contents.

Once a confidence level is determined at block 617 or if any overlapping surfaces have been resolved (block 616), it is determined if the symbol is the last symbol in the set of identified symbols at block 618. If the symbol is not the last symbol in the set of identified symbols at block 618, the process 600 returns to block 604. If the symbol is the last symbol in the set of identified symbols at block 618, the process 600 may identify any identified symbols that appear more than once in the set of identified symbols (e.g., the symbol is identified in more than one image). For each symbol that appears more than once in the set of identified symbols (e.g., each symbol with more than one associated image), the symbol assignment results for the symbol are aggregated at block 620. In some embodiments, aggregation may be used to determine if there is a conflict between the symbol assignment results for each symbol (e.g., for a symbol associated with two images, the symbol assignment results for each image is different) and to resolve any conflicts. An example of an aggregation process is described further below with respect to FIG. 6C. Different symbol assignment results between different images associated with a particular symbol may be caused by, for example, irregular motion (e.g., an object rocking as it translates on a conveyor), error in dimensional data, calibration, etc. In some embodiments, the aggregation of the symbol assignment results may be performed in the 2D image space. In some embodiments, the aggregation of the symbol assignment results may be performed in 3D space. At block 622, the symbol assignment result may be stored, for example in a memory.

As mentioned above, if the image associated with an identified symbol includes overlapping surfaces between two or more objects in the image, the overlapping surfaces may be resolved to identify or confirm the symbol assignment. FIG. 6B illustrates a method for resolving overlapping surfaces of a plurality of objects in an image for assigning a symbol to one of the plurality of objects in accordance with an embodiment of the technology. At block 632, process 630 compares the 2D location of the symbol to the 2D boundary and surfaces (e.g., polylines) of each object in an overlapping region. At block 634, the position of each overlapping object (or surface of each object) in the image relative to the imaging device FOV of the imaging device used to capture the image containing the symbol may be identified. For example, it may be determined which object (or object surface) is in front in the FOV of the imaging device and which object is in back in the FOV of the imaging device. At block 636, the object causing the overlap (or occlusion) may be determined based on the position of the overlapping objects (or object surfaces) relative to the imaging device field of view. For example, the object (or object surface) in front in the imaging device FOV may be identified as the occluding object (or object surface). At block 638, the symbol may be assigned to the occluding object (or object surface).

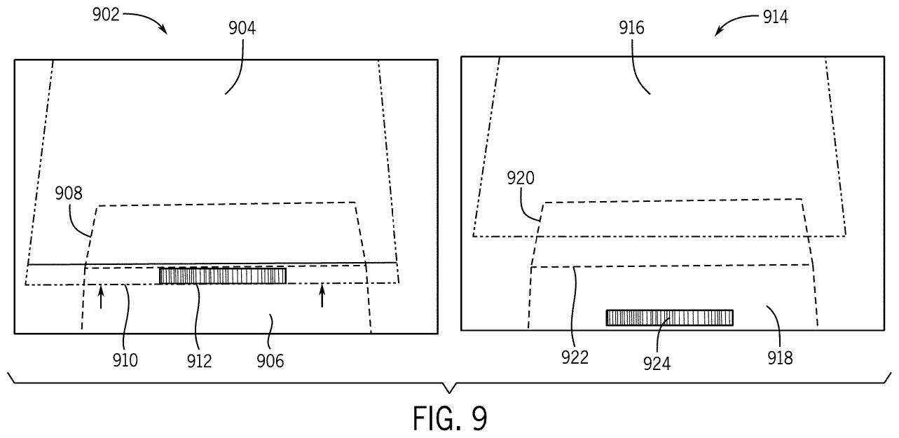

When the symbol has been assigned to the occluding object (or object surface), process 640 may determine whether further analysis or refinement of the symbol assignment may be performed. In some embodiments, further analysis may be performed for every symbol assignment in an image with overlapping objects after the symbol is assigned to the occluding object or object surface). In another embodiment, further analysis may not be performed for symbol assignments in an image with overlapping objects after the symbol is assigned to the occluding object or object surface. In some embodiments, further analysis may be performed for a symbol assignment in an image with overlapping objects after the symbol is assigned to the occluding object or object surface if one or more parameters of the object (or object surfaces) and/or location of the symbol meet a predetermined criteria. For example, in FIG. 6B, at block 640, if the 2D location of the symbol is within a predetermined threshold of an edge of the overlapping region, then further analysis may be performed at blocks 642 to block 646. In some embodiments, the predetermined threshold may be a proximity of one or more boundaries of the symbol (e.g., defined by the 2D location of the symbol) to an edge or boundary of the overlapping region between objects (or object surfaces) as illustrated on FIG. 9. In example image 902 in FIG. 9, a symbol 912 is closer to an edge 910 of an overlapping region 908 between a first object 904 and a second object 906 than the predetermined threshold (e.g., a predetermined number of pixels or mm). Accordingly further analysis may be performed on the symbol assignment. In the example image 914 in FIG. 9, a symbol 924 is farther from an edge 922 of an overlapping region 920 between a first object 916 and a second object 918 than the predetermined threshold. Accordingly further analysis may not be performed on the symbol assignment.

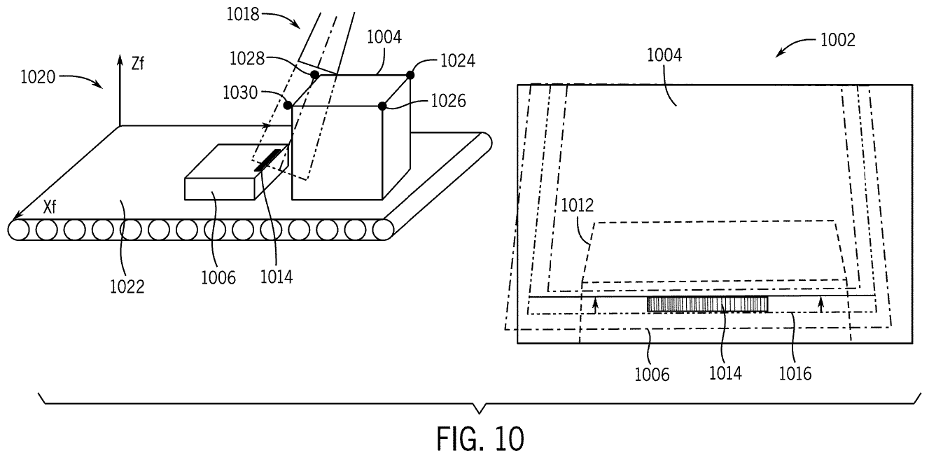

In some embodiments when further analysis is performed, at block 642, the image data associated with the symbol and information indicative of a 3D pose of the objects such as, for example, 3D corners of the objects in the image is retrieved. For example, the 2D image data associated with the one or more boundaries or edges of one or more of the overlapping objects may be retrieved. At block 644, one or more of the edges (e.g., the boundary determined from mapping the 3D corners of the object) of one or more of the overlapping objects may be refined using the content of the image data and image processing techniques. For example, as FIG. 10, an image 1002 with two overlapping objects (or object surfaces) 1004 and 1006 may be analyzed to further refine an edge 1016 of the first object 1004 based on a proximity of the symbol 1014 to an edge of the overlapping region 1012. Accordingly, the image data associated with the edge 1016 may be used to determine where the edge 1016 should be located. As mentioned above, errors in the location of edge 1016 may be the result of an error in the mapping of one or more of the 3D corners (e.g., 3D corners 1024, 1026, 1028 and 1030) of object 1004, for example, 3D corners 1028 and 1030. FIG. 10 also shows a corresponding 3D coordinate space 1020 (e.g., associated with a support structure such as conveyor 1022) and FOV 1018 of an imaging device (not shown) used to capture the image 1002. At block 646, once the location of the one or more edges of one or more of the overlapping objects is refined, the symbol may be assigned to an object in the image if, for example, the location of the symbol is inside the boundaries defined by the 2D location of the corners if the object. In addition, in some embodiments, a confidence level (or score) may be determined and assigned to the symbol assignment. In some embodiments, the confidence level (or score) may fall within a range of values such as, for example, between 0 and 1 or between 0% and 100%. For example, a confidence level of 40% may indicate a 40% chance the symbol is affixed to an object and/or surface and a 60% chance the symbol is not affixed to the object and/or surface. In some embodiments, the confidence level may be a normalized measure of how far the 2D location of the symbol is from the boundaries of an overlapping region, for example, the confidence level may be higher when the 2D location of the symbol in the image is farther from the boundaries (or edge) of the overlapping region and lower when the 2D location of the symbol is very close to the boundaries (or edges) of the overlapping region. In some embodiments, the confidence level may also be determined based on the image processing technique used to refine the location of one or more edges of one or more of the overlapping objects and the confidence in the technique to find the correct edge location based on the image contents. In some embodiments, the confidence level may also be based on one or more additional factors including, but not limited to, whether the 2D location of the symbol is inside or outside the boundaries defined by the 2D location of the points (e.g., corresponding to corners) of the object, whether the 2D location of the symbol is inside or outside the boundaries of the overlapping region, a ratio of the distance of the 2D location of the symbol from the boundaries of different objects in the FOV, and whether there are overlapping objects in the image. At block 650, the symbol assignment and confidence level may be stored in, for example, a memory.

At block 640 of FIG. 6B, if the 2D location of the symbol is not within a predetermined threshold of an edge of the overlapping region, the symbol assignment from block 632 may be assigned a confidence level (or score) at block 648. As discussed above, the confidence level (or score) may fall within a range of values such as, for example, between 0 and 1 or between 0% and 100%. In some embodiments, the confidence level may be a normalized measure of how far the 2D location of the symbol is from the boundaries of an overlapping region, for example, the confidence level may be higher when the 2D location of the symbol in the image is farther from the boundaries (or edge) of the overlapping region and lower when the 2D location of the symbol is very close to the boundaries (or edges) of the overlapping region. As mentioned, in some embodiments, the confidence level may also be based on one or more additional factors including, but not limited to, the image processing technique used to refine the location of one or more edges of the overlapping objects and the confidence in the technique to find the correct edge location based on the image contents, whether the 2D location of the symbol is inside or outside the boundaries defined by the 2D location of the points (e.g., corresponding to corners) or the object, whether the 2D location of the symbol is inside or outside the boundaries of the overlapping region, a ratio of the distance of the 2D location of the symbol from the boundaries of different objects in the FOV, and whether there are overlapping objects in the image. At block 650, the symbol assignment and confidence level may be stored in, for example, a memory.

As discussed above with respect to block 620 of FIG. 6A, the symbol assignment results for any identified symbol that appears more than once in the set of identified symbols (e.g., the symbol is identified in more than one image) may be aggregated to, for example, determine if there is a conflict between the symbol assignment results for the particular symbol and to resolve any conflicts. FIG. 6C illustrates a method for aggregating symbol assignment results for a symbol in accordance with an embodiment of the technology. At block 662, process 660 identifies any repeated symbol in the set of identified symbols, for example, each symbol that has more than one associated image. At block 664, for each repeated symbol, the process 660 may identify each associated image in which the symbol appears. At block 666, process 660 may compare the symbol assignment result for each image associated with the repeated symbol. At block 668, if all of the symbol assignment results are the same for each image associated with the repeated symbol, the common symbol assignment results for the images associated with the repeated symbol may be stored at block 678, for example, in a memory.

At block 668, if there is at least one different symbol assignment result in the symbol assignment results for the images associated with the repeated symbol, process 660 may determine at block 670 if there is at least one assignment result associated with an image without overlapping objects (e.g., see image 702 in FIG. 7). If there is at least one symbol assignment result associated with an image without overlapping objects, the process 660 may select the symbol assignment result for the image without the overlapping object at block 672 and the selected symbol assignment result may be stored at block 678, for example, in a memory.

If there is not at least one symbol assignment result associated with an image without overlapping objects at block 670, the process 660 may compare the confidence levels (or scores) of the symbol assignment results for the image associated with the repeated symbol at block 674. In some embodiments, process 660 may not include blocks 670 and 672 and the confidence levels of all of the aggregated assignment results for a repeated symbol (for both images with and without overlapping objects) may be compared. At block 676, in some embodiments process 660 may select the assignment with the highest confidence level as the symbol assignment for the repeated symbol. At block 678, the selected symbol assignment may be stored, for example, in a memory.

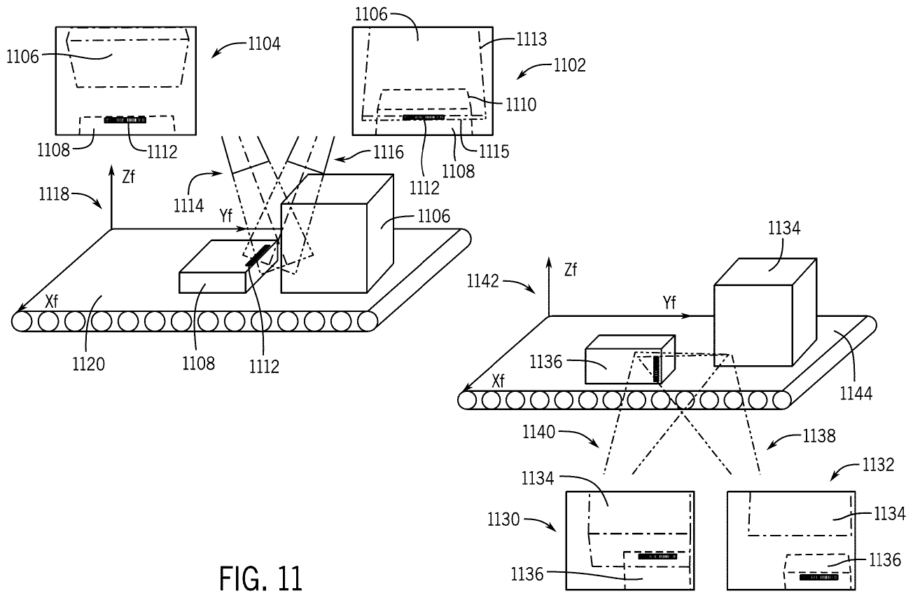

FIG. 11 illustrates examples of aggregating symbol assignment results for a symbol in accordance with an embodiment of the technology. In FIG. 11, example image 1102 illustrates a FOV 1116 of a first image device (not shown) capturing a first object 1106, a second object 1108 and a symbol 1112 on the second object 1108. Example image 1104 illustrates a FOV 1114 of a second image device (not shown) capturing the first object 1106, the second object 1108 and the symbol 1112 on the second object 1108. In image 1104, the first object 1106 and the second object 1108 do not overlap and in image 1102, the first object 1106 and the second object 1008 overlap. Accordingly, image 1102 and image 1104 may result in different symbol assignment results. For example, boundary (or edge) 1113 may represent the correct boundary of first object 1106 but due to errors on a top surface of object 1106 the edge may map to the edge 1115 which may result is assigning symbol 1112 to the incorrect object, namely, first object 1106. In contrast, in this example an error in the mapping of boundaries will not cause an ambiguity in a symbol assignment in image 1104 because of the separation between the surfaces of the first object 1106 and the second object 1108. As mentioned above with respect to FIG. 6C, because image 1104 does not include overlapping objects, the system may select the symbol assignment for symbol 1112 from image 1104. FIG. 11 also shows a corresponding 3D coordinate space 1118 (e.g., associated with a support structure such as conveyor 1120) for the example images 1102 and 1104. In another example in FIG. 11, example image 1130 illustrates a FOV 1140 of a first image device (not shown) capturing a first object 1134, a second object 1136 and a symbol on the second object 1136. Example image 1132 illustrates a FOV 1138 of a second image device (not shown) capturing the first object 1134, the second object 1136 and the symbol on the second object 1136. In image 1132, the first object 1134 and the second object 1136 do not overlap and in image 1132, the first object 1134 and the second object 1136 overlap. Accordingly, image 1130 and image 1132 may result in different symbol assignment results. As mentioned above with respect to FIG. 6C, because image 1132 does not include overlapping objects, the system may select the symbol assignment for the symbol from image 1132. FIG. 11 also shows a corresponding 3D coordinate space 1142 (e.g., associated with a support structure such as conveyor 1144) for the example images 1130 and 1132.

FIG. 12A shows an example of a factory calibration setup that can be used to find a transformation between an image coordinate space and a calibration target coordinate space. As shown in FIG. 12A, an imaging device 1202 can generate images (e.g., image 808) that project points in a 3D factory coordinate space (Xf, Yf, Zf) onto a 2D image coordinate space (xi, yi). The 3D factory coordinate space can be defined based on a support structure 804 (which may sometimes be referred to as a fixture) that supports a calibration target used to find the transform between the factory coordinate space and the image coordinate space.

Generally, the overall goal of calibrating imaging device 1202 (e.g., a camera) is to find a transformation between a physical 3D coordinate space (e.g., in millimeters) and the image 2D coordinate space (e.g., in pixels). The transformation in FIG. 12A illustrates an example of such a transformation using a simple pinhole camera model. The transformation can have other nonlinear components (e.g., to represent lens distortion). The transformation can be split into extrinsic and intrinsic parameters. The extrinsic parameters can depend on the location and orientation of mounting the imaging device(s) with respect to the physical 3D coordinate space. The intrinsic parameters can depend on internal imaging device parameters (e.g., the sensor and lens parameters). The calibration process goal is to find value(s) for these intrinsic and extrinsic parameters. In some embodiments, the calibration process can be split into two parts, one part executed in the factory calibration and another part executed in the field.

FIG. 12B shows an example of coordinate spaces and other aspects for a calibration process, including a factory calibration and a field calibration that includes capturing multiple images of one or more sides of an object in accordance with an embodiment of the technology. As shown in 12B, a tunnel 3D coordinate space (e.g., the tunnel 3D coordinate space shown in FIG. 12B with axes Xt, Yt, Zt) can be defined based on a support structure 1222. For example, in FIG. 12B, a conveyor (e.g., as described above in connection with FIGS. 1A, 1B, and 2A) is used to define the tunnel coordinate space, with an origin 1224 at a particular location along the conveyor (e.g., with Yt=0 defined at a particular point along the conveyor, for example at a point defined based on the location of a photo eye as described in U.S. Patent Application Publication No. 2021/0125373, Xt=0 defined at one side of the conveyor, and Zt=0 defined at the surface of the conveyor). As another example, the tunnel coordinate space can be defined based on a stationary support structure (e.g., as described above in connection with FIG. 3). Alternatively, in some embodiments, the tunnel coordinate space can be defined based on a 3D sensor (or dimensioner) used to measure the location of an object.

Additionally, in some embodiments, during a calibration process (e.g., a field calibration process), an object coordinate space (Xb, Yb, Zb) can be defined based on an object (e.g., object 1226) being used to perform the calibration. For example, as shown in FIG. 12B, symbols can be placed onto an object (e.g., object 1226), where each symbol is associated with a particular location in object coordinate space.

FIG. 12C shows an example of a field calibration process 1230 for generating an imaging device model useable to transform coordinates of an object in a 3D coordinate space associated with the system for capturing multiple images of each side of the object into coordinates in a 2D coordinate space associated with the imaging device in accordance with an embodiment of the technology. In some embodiments, an imaging device (e.g., imaging device 1202) can be calibrated before being installed in the field (e.g., a factory calibration can be performed). Such a calibration can be used to generate an initial camera model that can be used to map points in 3D factory coordinate space to 2D points in the image coordinate space. For example, as shown in FIG. 12C, a factory calibration process can be performed to generate extrinsic parameters that can be used with intrinsic parameters to map points in the 3D factory coordinate space into 2D points in the image coordinate space. The intrinsic parameters can represent parameters that relate pixels of the image sensor of an imaging device to an image plane of the imaging device, such as a focal length, an image sensor format, and a principal point. The extrinsic parameters can represent parameters that relate points in 3D tunnel coordinates (e.g., with an origin defined by a target used during factory calibration) to 3D camera coordinates (e.g., with a camera center defined as an origin).

A 3D sensor (or dimensioner) can measure a calibration object (e.g., a box with codes affixed that define a position of each code in the object coordinate space, such as object 1226) in the tunnel coordinate space, and the location in tunnel coordinate space can be correlated with locations in image coordinate space of the calibration object (e.g., relating coordinates in (Xt, Yt, Zt) to (xi, yi)). Such correspondence can be used to update the camera model to account for the transformation between the factory coordinate space and the tunnel coordinate space (e.g., by deriving a field calibration extrinsic parameter matrix, which can be defined using a 3D rigid transformation relating one 3D coordinate space such as the tunnel coordinate space to another, such as the factory coordinate space). The field calibration extrinsic parameter matrix can be used in conjunction with the camera model derived during factory calibration to relate points in the tunnel coordinate space (Xt, Yt, Zt) to points in image coordinate space (xi, yi). This transformation can be used to map 3D points of an object measured by a 3D sensor to an image of the object, such that the portions of the image corresponding to a particular surface can be determined without analyzing the content of the image. Note that the model depicted in FIGS. 12A, 12B, and 12C is a simplified (e.g., pinhole camera) model that can be used to correct for distortion caused by projection to avoid overcomplicating the description, and more sophisticated models (e.g., including lens distortion) can be used in connection with mechanisms described herein.

Note that this is merely an example, and other techniques can be used to define a transformation between tunnel coordinate space and image coordinate space. For example, rather than performing a factory calibration and a field calibration, a field calibration can be used to derive a model relating tunnel coordinates to image coordinates. However, this may cause replacement of an imaging device to be more cumbersome, as the entire calibration may need to be performed to use a new imaging device. In some embodiments, calibrating an imaging device using a calibration target to find a transformation between a 3D factory coordinate space and image coordinates, and calibrating the imaging device in the field to find a transformation that facilitates mapping between tunnel coordinates (e.g., associated with a conveyor, a support platform, or a 3D sensor) can facilitate replacement of an imaging device without repeating the field calibration.

FIGS. 13A and 13B show examples of field calibration processes associated with difference positions of a calibration target (or targets) in accordance with an embodiment of the technology m . As shown in FIG. 13A, mechanisms described herein can map 3D points associated with an object (e.g., the corners of the object) defined in a tunnel coordinate space specified based on geometry of a conveyor (or other transport system and/or support structure) to points in an image coordinate space based on a model generated based on a factory calibration and a field calibration. For example, as shown in FIG. 13A, mechanisms described herein can map 3D points associated with box 1328 defined in tunnel coordinates (Xt, Yt, Zt) with respect to support structure 1322 to points in an image coordinate space associated with an imaging device (e.g., imaging device 1202 shown in FIGS. 12A and 12B). In some embodiments, the 2D points of each corner in image space can be used with knowledge of the orientation of the imaging device to associate each pixel in the image with a particular surface (or side) of an object (or determine that a pixel is not associated with the object) without analyzing the content of the image.

For example, as shown in FIG. 13A, the imaging device (e.g., imaging device 1202 shown in FIGS. 12A and 12B) is configured to capture images (e.g., image 1334) from a front-top angle with respect to the tunnel coordinates (e.g., with field of view 1332). In such an example, 2D locations of the corners of the box can be used to automatically associate a first portion of the image with a “left” side of the box, a second portion with a “front” side of the box, and a third portion with a “top” side of the box. As shown in FIG. 13A, only two of the corners are located within the image 1332, with the other 6 corners falling outside the image. Based on the knowledge that the imaging device is configured to capture images from above the object and/or based on camera calibration (e.g., which facilitates a determination of the location of the imaging device and the optical axis of the imaging device with respect to the tunnel coordinates), the system can determine that the leading left bottom corner and leading left top corner are both visible in the image.

As shown in FIG. 13B, a second image 1336 is captured after the box 1328 moved a distance ΔYt along the conveyor. As described above, a motion measurement device (e.g., an encoder) can be used to determine a distance that the box 1328 has traveled between when the first image 1334 shown in FIG. 13A was captured and when the second image 1336 was captured. Operation of such a motion measurement device (e.g., implemented as an encoder) is described in U.S. Pat. No. 9,305,231, and U.S. Patent Application Publication No. 2021/0125373, filed Oct. 26, 2020, which is hereby incorporated herein by reference in its entirety. The distance traveled and the 3D coordinates can be used to determine the 2D points in the second image 1336 corresponding to corners of the box 1328. Based on the knowledge that the imaging device is configured to capture images from above the object, the system can determine that the trailing top right corner is visible in the image 1336, but the trailing bottom right corner is obstructed by the top of the box. In addition, the top surface of the box is visible but the back and the right surfaces are not visible.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIG. 6 can be executed or performed in any order or sequence not limited to the order and sequence shown and described in the figures. Also, some of the above steps of the processes of FIG. 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for assigning a symbol to an object in an image, the method comprising:
receiving the image captured by an imaging device, the symbol located within the image;
receiving, in a first coordinate system, a three-dimensional (3D) location of one or more points that corresponds to pose information indicative of a 3D pose of the object in the image;
mapping the 3D location of the one or more points of the object to a 2D location within the image; and
assigning the symbol to the object based on a relationship between a 2D location of the symbol in the image and the 2D location of the one or more points of the object in the image.

2. The method according to claim 1, further comprising:
determining a surface of the object based on the 2D location of the one or more points of the object within the image; and
assigning the symbol to the surface of the object based on a relationship between the 2D location of the symbol in the image and the surface of the object.

3. The method according to claim 1, further comprising:
determining that the symbol is associated with a plurality of images;
aggregating the assignments of the symbol for each image of the plurality of images; and
determining if at least one of the assignments of the symbol differs from the remaining assignments of the symbol.

4. The method according to claim 1, further comprising determining an edge of the object in the image based on imaging data of the image.

5. The method according to claim 1, further comprising determining a confidence score for the symbol assignment.

6. The method according to claim 1, wherein the 3D location of one or more points is received from aa 3D sensor.

7. The method according to claim 1, wherein the image includes a plurality of objects, the method further comprising:
determining whether the plurality of objects overlap in the image.

8. The method according to claim 1, wherein the image includes the object having a first boundary with a margin and a second object having a second boundary with a second margin, and the method further comprising:
determining whether the first boundary and the second boundary overlap in the image.

9. The method according to claim 1, wherein the 3D location of the one or more points is acquired at a first time and the image is acquired at a second time, and
wherein the mapping of the 3D location of the one or more points to the 2D location within the image comprises mapping the 3D location of the one or more points from the first time to the second time.

10. The method according to claim 1, wherein the pose information comprises a corner of the object in the first coordinate space.

11. The method according to claim 1, wherein the pose information comprises point cloud data.

12. A system for assigning a symbol to an object in an image, the system comprising:
a calibrated imaging device configured to capture images; and
a processor device programmed to:
receive the image captured by the calibrated imaging device, the symbol located within the image;
receive, in a first coordinate system, a three-dimensional (3D) location of one or more points that corresponds to pose information indicative of a 3D pose of the object in the image;
map the 3D location of the one or more points of the object to a 2D location within the image; and
assign the symbol to the object based on a relationship between a 2D location of the symbol in the image and the 2D location of the one or more points of the object in the image.

13. The system according to claim 12, further comprising:
a conveyor configured to support and transport the object; and
a motion measurement device coupled to the conveyor and configured to measure movement of the conveyor.

14. The system according to claim 12, further comprising a 3D sensor configured to measure the 3D location of the one or more points.

15. The system according to claim 12, wherein the pose information comprises a corner of the object in the first coordinate space.

16. The system according to claim 12, wherein the pose information comprises point cloud data.

17. The system according to claim 12, wherein the processor device is further programmed to:
determine a surface of the object based on the 2D location of the one or more points of the object within the image; and
assign the symbol to the surface of the object based on a relationship between the 2D location of the symbol in the image and the surface of the object.

18. The system according to claim 12, wherein the at least one processor device is further programmed to:
determine that the symbol is associated with a plurality of images;
aggregate the assignments of the symbol for each image of the plurality of images; and
determine if at least one of the assignments of the symbol differs from the remaining assignments of the symbol.

19. The system according to claim 12, wherein the image associated with the symbol includes a plurality of objects and the processor device is further programmed to determine whether the plurality of objects overlap in the image.

20. The system according to claim 12, wherein the image includes the object having a first boundary with a margin and a second object having a second boundary with a second margin, and the processor device is further programmed to:
determine whether the first boundary and the second boundary overlap in the image

21. The system according to claim 12, wherein assigning the symbol to the object comprises assigning the symbol to a surface.

22. A method for assigning a symbol to an object in an image, the method comprising:
receiving the image captured by an imaging device, the symbol located within the image receiving, in a first coordinate system, a three-dimensional (3D) location of one or more points that corresponds to pose information indicative of a 3D pose of one or more objects;
mapping the 3D location of the one or more points of the object to a 2D location within the image in a second coordinate space;
determining a surface of the object based on the 2D location of the one or more points of the object within the image in the second coordinate space; and
assigning the symbol to the surface based on a relationship between a 2D location of the symbol in the image and the 2D location of the one or more points of the object in the image.

23. The system according to claim 22, wherein assigning the symbol to the surface comprises determining an intersection between the surface and the image in the second coordinate space.

24. The system according to claim 22, further comprising determining a confidence score for the symbol assignment.
